(19) United States
(12) Patent Application Publication
(10) Pub. No.: US 2011/0217597 A1
(43) Pub. Date: Sep. 8, 2011

(54) NONAQUEOUS ELECTROLYTE BATTERY

(75) Inventors: Shinichi Katayama, Fukushima (JP); Haruo Watanabe, Kanagawa (JP); Tomoyo Ooyama, Fukushima (JP); Hideki Nakai, Fukushima (JP); Shunsuke Saito, Fukushima (JP)

(73) Assignee: SONY CORPORATION, Tokyo (JP)

(21) Appl. No.: 13/033,130

(22) Filed: Feb. 23, 2011

(30) Foreign Application Priority Data
Mar. 2, 2010 (JP) P2010-044805

(51) Int. Cl. H01M 10/0561

(52) U.S. Cl. 429/300

(57) ABSTRACT

A nonaqueous electrolyte battery is provided and includes a positive electrode having a positive electrode active material layer containing a positive electrode active material formed on at least one surface of a positive electrode collector, a negative electrode having a negative electrode active material layer containing a negative electrode active material formed on at least one surface of a negative electrode collector, a separator provided between the positive electrode and the negative electrode, and an electrolyte. A coating film in a gel form containing an amorphous polyacid and/or polyacid compound containing one or more kinds of a polyelement is formed on the surface of at least a part of the negative electrode. Also, at least one of the polyacid and the polyacid compound contains a polyatom ion with a valence of 6 and a polyatom ion with a valence of less than 6.

### CROSS REFERENCES TO RELATED APPLICATIONS

The present application claims priority to Japanese Patent Application JP 2010-044805 filed on Mar. 2, 2010, the entire contents of which is hereby incorporated by reference.

### BACKGROUND

The present disclosure relates to a nonaqueous electrolyte battery capable of suppressing the gas generation and blister of the battery to be caused following the gas generation.

In recent years, following the spread of portable appliances such as video cameras and laptop personal computers, there has been an increased demand for small-sized and high-capacity secondary batteries. Secondary batteries which are currently used include a nickel-cadmium battery and a nickel-hydrogen battery each using an alkaline electrolytic solution. However, the voltage of such a battery is low as about 1.2 V, so that it is difficult to enhance an energy density. For that reason, studies have been made as to a lithium metal secondary battery using a lithium metal having a specific gravity of 0.534, a value of which is the lowest in solid simple substances, is also extremely poor in a potential and has the largest current capacity per unit weight in metal negative electrode materials.

However, in secondary batteries using a lithium metal for a negative electrode, when charged, dendritic lithium (dendrite) is deposited on the surface of the negative electrode and grows due to a charge/discharge cycle. Not only the growth of the dendrite deteriorates a charge/discharge cycle characteristic of the secondary battery, but in the worst case, the grown dendrite breaks through a diaphragm (separator) to be disposed so as to prevent a positive electrode from being in contact with a negative electrode. As a result, there is involved such a problem that an internal short circuit is generated to cause thermorunaway, whereby the battery is broken.

There has hitherto been proposed an electrode material containing a heteropolyacid. For example, Patent Document 1 (JP-A-59-060818) proposes an electrode material provided with an ion associate containing a heteropolyacid on the electrode surface for the purpose of controlling an oxidation-reduction potential. Also, Patent Document 2 (U.S. Pat. No. 4,630,176) describes that by adsorbing a heteropolyacid onto carbon, a leakage current is reduced, and a charge capacity is increased. Also, Patent Document 3 (U.S. Pat. No. 4,633,372) describes that by adsorbing a heteropolyacid onto carbon, a reversible oxidation-reduction reaction becomes possible, and a charge capacity is increased without reducing charge capability of a carbon material.

Patent Document 4 (U.S. Pat. No. 5,501,922) describes that by using a polymer containing a heteropolyacid, the characteristics are improved. Patent Document 5 (JP-T-2002-507310) describes that by incorporating a heteropolyacid into a solid electrolyte, high rechargeability, high energy density and so on are realized. Patent Document 6 (JP-T-2007-511873) describes that by incorporating a heteropolyacid into a composite membrane, proton conductivity becomes possible even at high temperatures.

Meanwhile, as described in Patent Document 7 (JP-A-2002-289188), there is also proposed an invention using, as an active material, an aggregate obtained by aggregating a heteropolyacid. Patent Document 8 (JP-A-2004-214116) describes that a heteropolyacid having been made insoluble in water is used as an active material. In Patent Documents 7 and 8, it may be considered that when the heteropolyacid is heat treated, the heteropolyacid is polymerized, whereby it becomes insoluble in a solvent.

### SUMMARY

In secondary batteries using a lithium transition metal complex oxide as a positive electrode active material, there was involved such a problem that the gas generation is caused in the inside of the battery, so that an internal pressure of the battery is easy to increase. In particular, in batteries using a laminated film for packaging, there was involved such a problem that the battery is easy to expand due to the gas generation. In particular, in secondary batteries using a lithium transition metal complex oxide composed mainly of nickel as a positive electrode active material, the foregoing problem is easily caused.

Also, when the battery temperature excessively increases, a separator is more contracted. Then, when the separator becomes smaller than the size of each of a positive electrode and a negative electrode, the positive electrode and the negative electrode come into contact with each other, so that it may be impossible to prevent the foregoing problem of heat generation of the battery from occurring.

However, in Patent Documents 1 to 8, the viewpoint of the foregoing safety is not investigated. Patent Documents 1 to 6 focus on modification of the active material in the battery, or modification of the electrolyte or separator. Also, Patent Documents 7 and 8 are concerned with use of the heteropolyacid for the active material itself but not concerned with an enhancement of the safety by using the heteropolyacid.

In consequence, it is desirable to provide a nonaqueous electrolyte battery capable of solving the foregoing problems and having both high battery characteristics and safety.

According to one embodiment, there is provided a nonaqueous electrolyte battery including

a positive electrode having a positive electrode active material layer containing a positive electrode active material formed on at least one surface of a positive electrode collector;

a negative electrode having a negative electrode active material layer containing a negative electrode active material formed on at least one surface of a negative electrode collector;

a separator provided between the positive electrode and the negative electrode; and

an electrolyte, wherein

a coating film in a gel form containing an amorphous polyacid and/or polyacid compound containing one or more kinds of a polyelement is formed on the surface of at least a part of the negative electrode, and

at least one of the polyacid and the polyacid compound contains a polyatom ion with a valence of 6 and a polyatom ion with a valence of less than 6.

In the embodiment, it is preferable that when the surface of the polyacid or polyacid compound existing in the negative electrode is measured by the X-ray photoelectron spectroscopy (XPS), a spectrum assigned to an inner shell electron of 4f7/2 of tungsten has a peak in each of a region of 32.0 eV or more and not more than 35.4 eV and a region of 35.4 eV or more and not more than 36.9 eV.

Also, in the embodiment, it is preferable that when the surface of the polyacid or polyacid compound existing in the negative electrode is measured by the X-ray photoelectron spectroscopy (XPS), a spectrum assigned to an inner shell electron of 3d5/2 of molybdenum has a peak in each of a region of 227.0 eV or more and not more than 231.5 eV and a region of 231.5 eV or more and not more than 233.0 eV.

According to the embodiment, the gas generation in the inside of the battery can be suppressed. Also, for example, the separator is hardly contracted, and even when contracted, it is able to prevent direct contact of the positive electrode and the negative electrode with each other by interposing a layer with high resistance therebetween from occurring.

According to the embodiment, it is possible to suppress the expansion of the nonaqueous electrolyte battery and to obtain high safety.

Additional features and advantages are described herein, and will be apparent from the following Detailed Description and the figures.

### BRIEF DESCRIPTION OF THE FIGURES

FIG. 1 is a perspective view showing a configuration example of a nonaqueous electrolyte battery according an embodiment.

FIG. 2 is a sectional view along a II-II line of a wound electrode body 10 shown in FIG. 1.

FIG. 3 is an SEM photograph of a negative electrode surface according to an embodiment.

FIG. 4 is an example of a secondary ion spectrum by the time-of-flight secondary ion mass spectrometry (ToF-SIMS) on a negative electrode surface having a deposit deposited thereon by the addition of silicotungstic acid into a battery system.

FIG. 5 is an example of a radial structure function of a W—O bond obtained by the Fourier transformation of a spectrum by the X-ray absorption fine structure (XAFS) analysis on a negative electrode surface having a deposit deposited thereon by the addition of silicotungstic acid into a battery system.

FIG. 6 is a sectional view showing a configuration example of a nonaqueous electrolyte battery according to an embodiment.

FIG. 7 is a sectional view showing enlargedly a part of a wound electrode body 30 shown in FIG. 6.

FIG. 8 is a sectional view showing a configuration example of a nonaqueous electrolyte battery according an embodiment.

FIG. 9 is a sectional view showing a configuration example of a nonaqueous electrolyte battery according an embodiment.

FIG. 10 is a graph showing the analysis results of a negative electrode surface of Sample 1-3 by XPS.

### DETAILED DESCRIPTION

Embodiments are hereunder described by reference to the accompanying drawings. The description is made in the following order.

1. First embodiment (an example of a nonaqueous electrolyte battery in which both a reduced material of at least one of a polyacid and a polyacid compound and a non-reduced material of at least one of a polyacid and a polyacid compound are existent on a negative electrode surface)

2. Second embodiment (an example of a nonaqueous electrolyte battery in which at least one of a polyacid and a polyacid compound is deposited on each of a negative electrode surface and a positive electrode surface)

3. Third embodiment (an example of a nonaqueous electrolyte battery in which a negative electrode and a separator are immobilized by deposits of a polyacid and a polyacid compound)

4. Fourth embodiment (an example of a nonaqueous electrolyte battery using an electrolytic solution)

5. Fifth embodiment (an example of a nonaqueous electrolyte battery of a cylindrical type)

6. Sixth embodiment (an example of a nonaqueous electrolyte battery having a rectangular shape)

7. Seventh embodiment (an example of a manufacturing method of a nonaqueous electrolyte battery by incorporating at least one of a heteropolyacid and a heteropolyacid compound into a negative electrode active material layer, thereby depositing at least one of a polyacid and a polyacid compound on a negative electrode surface)

8. Eighth embodiment (an example of a manufacturing method of a nonaqueous electrolyte battery by incorporating at least one of a heteropolyacid and a heteropolyacid compound into a positive electrode active material layer, thereby depositing at least one of a polyacid and a polyacid compound on a negative electrode surface)

9. Ninth embodiment (an example of a nonaqueous electrolyte battery using a laminated electrode body)

10. Other embodiments (modification examples)

### 1. First Embodiment

In a first embodiment, a nonaqueous electrolyte secondary battery in which at least one of a polyacid and a polyacid compound is incorporated into an electrolyte, thereby forming a coating film in a gel form containing an amorphous polyacid and/or polyacid compound containing one or more kinds of a polyelement on the surface of a negative electrode is described.

(1-1) Configuration of Nonaqueous Electrolyte Battery

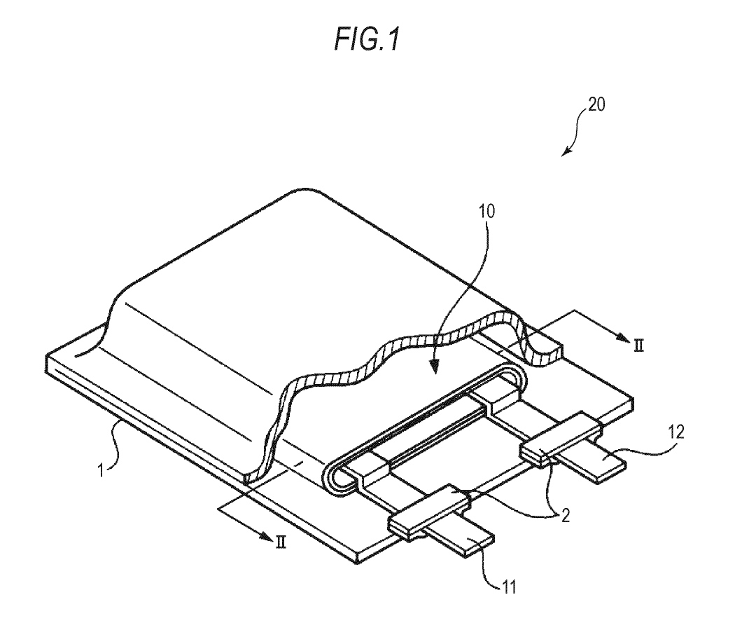

FIG. 1 is a perspective view showing a configuration example of a nonaqueous electrolyte battery according the first embodiment. This nonaqueous electrolyte battery is, for example, a nonaqueous electrolyte secondary battery. This nonaqueous electrolyte battery has a configuration in which a wound electrode body 10 having a positive electrode lead 11 and a negative electrode lead 12 installed therein is housed in the inside of a film-shaped package member 1 and has a flat shape.

Each of the positive electrode lead 11 and the negative electrode lead 12 is, for example, formed in a strip shape and led out from the inside of the package member 1 toward the outside in, for example, the same direction. The positive electrode lead 11 is, for example, constituted of a metal material such as aluminum (Al), and the negative electrode lead 12 is, for example, constituted of a metal material such as nickel (Ni).

The package member 1 is a laminated film having a structure in which, for example, an insulating layer, a metal layer and an outermost layer are laminated in this order and stuck by means of lamination processing or the like. In the package member 1, for example, the respective outer edges are allowed to closely adhere to each other by means of fusion or with an adhesive in such a manner that the side of the insulating layer is faced inward.

The insulating layer is, for example, constituted of a polyolefin resin such as polyethylene, polypropylene, modified polyethylene, modified polypropylene and a copolymer thereof. This is because the moisture permeability can be made low, and the air tightness is excellent. The metal layer is constituted of aluminum, stainless steel, nickel, iron or the like in a foil form or a plate form. The outermost layer may be, for example, constituted of the same resin as that in the insulating layer, or may be constituted of nylon or the like. This is because the strength against breakage, piercing or the like can be enhanced. The package member 1 may be provided with other layer than the insulating layer, the metal layer and the outermost layer.

A contact film 2 is inserted between the package member 1 and each of the positive electrode lead 11 and the negative electrode lead 12 for the purposes of enhancing adhesion between each of the positive electrode lead 11 and the negative electrode lead 12 and the inside of the package member 1 and preventing invasion of the outside air. The contact film 2 is constituted of a material having adhesion to each of the positive electrode lead 11 and the negative electrode lead 12. When each of the positive electrode lead 11 and the negative electrode lead 12 is constituted of the foregoing metal material, it is preferable that the contact film 2 is constituted of a polyolefin resin such as polyethylene, polypropylene, modified polyethylene and modified polypropylene.

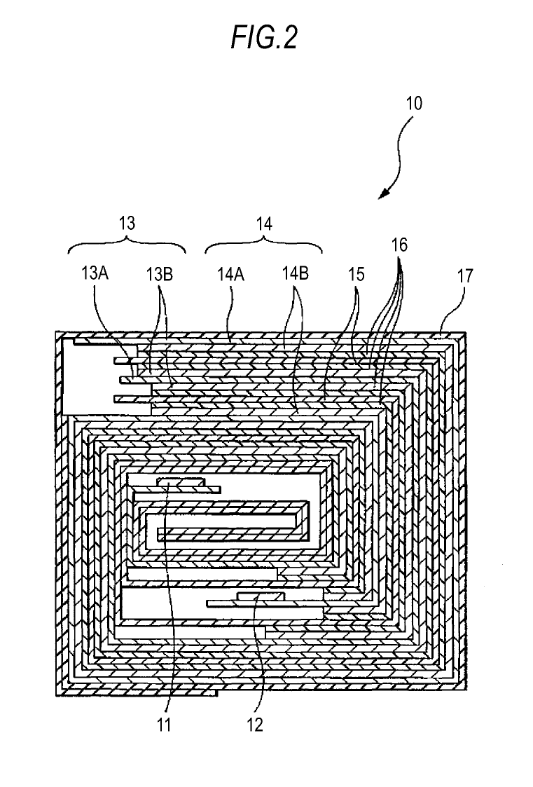

FIG. 2 is a sectional view along a II-II line of the wound electrode body 10 shown in FIG. 1. The wound electrode body 10 is one prepared by laminating a positive electrode 13 and a negative electrode 14 via a separator 15 and an electrolyte 16 and winding the laminate, and an outermost peripheral part of the wound laminate is protected by a protective tape 17.

[Positive Electrode]

The positive electrode 13 has, for example, a positive electrode collector 13A and a positive electrode active material layer 13B provided on the both surfaces of this positive electrode collector 13A. For the positive electrode collector 13A, for example, a metal foil such as an aluminum foil can be used.

The positive electrode active material layer 13B contains a positive electrode active material, a conductive assistant such as carbon materials and a binder such as polyvinylidene fluoride and polytetrafluoroethylene.

[Positive Electrode Active Material]

The positive electrode active material is a lithium complex oxide particle containing nickel and/or cobalt. This is because by using this lithium complex oxide particle, a high capacity and a high discharge potential are obtainable. This lithium complex oxide particle is, for example, a lithium complex oxide particle having a structure of a layered rock salt type expressed by an average composition represented by the following formula (1). This lithium complex oxide particle may be a primary particle or a secondary particle.

LiₐCo_{b}Ni_{c}M1_{1-b-c}O_{d} (1)

In the formula (1), M1 is at least one element selected from the group consisting of boron (B), magnesium (Mg), aluminum (Al), silicon (Si), phosphorus (P), sulfur (S), titanium (Ti), chromium (Cr), manganese (Mn), iron (Fe), copper (Cu), zinc (Zn), gallium (Ga), germanium (Ge), yttrium (Y), zirconium (Zr), molybdenum (Mo), silver (Ag), barium (Ba), tungsten (W), indium (In), tin (Sn), lead (Pb) and antimony (Sb). a, b, c and d are values falling within the ranges of (0.2≦a≦1.4), (0≦b≦1.0), (0≦c≦1.0) and (1.8≦d≦2.2), respectively. The composition of lithium varies depending upon the charge/discharge state, and the value of a represents a value in a completely discharged state.

Here, in the formula (1), the range of a is, for example, (0.2≦a≦1.4). When the value of a is smaller than the foregoing range, the layered rock salt structure of the basic crystal structure of the lithium complex oxide collapses, whereby recharge becomes difficult, and the capacity is significantly lowered. When the value of a is larger than the foregoing range, lithium diffuses outside the foregoing complex oxide particle, whereby not only the control of the basicity in a subsequent treatment step is impaired, but hindrance of the acceleration of gelation during kneading of a positive electrode paste is finally caused.

The lithium complex oxide represented by the formula (1) is one which may contain lithium excessively as compared with the existing lithium complex oxides. That is, the value of a showing the lithium composition of the lithium complex oxide represented by the formula (1) may be larger than 1.2. Here, the value of 1.2 is one disclosed as the lithium composition of the existing lithium complex oxides of this type, and the same action and effect as in the present invention are obtainable through the same crystal structure as in the case of a=1 (see, for example, JP-A-2008-251434 which is an earlier application by the same assignee of the present application).

Even when the value of a showing the lithium composition of the lithium complex oxide represented by the formula (1) is larger than 1.2, the crystal structure of the lithium complex oxide is the same as in the case where the value of a is not more than 1.2. Also, even if the value of a showing the lithium composition in the formula (1) is larger than 1.2, when the value of a is not more than 1.4, the chemical state of a transition metal constituting the lithium complex oxide in the oxidation-reduction reaction following the charge/discharge is not significantly changed as compared with the case where the value of a is not more than 1.2.

The ranges of b and c are, for example, (0≦b≦1.0) and (0≦c≦1), respectively. When the values of b and c are smaller than the foregoing ranges, respectively, the discharge capacity of the positive electrode active material is reduced. When the values of b and c are larger than the foregoing range, respectively, the stability of the crystal structure of the complex oxide particle is lowered, thereby causing a lowering of the capacity of the positive electrode active material by repetition of charge/discharge and a lowering of the safety.

The range of d is, for example, (1.8≦d≦2.2). When the value of d is smaller than the foregoing range or larger than the foregoing range, the stability of the crystal structure of the complex oxide particle is lowered, thereby causing a lowering of the capacity of the positive electrode active material by repetition of charge/discharge and a lowering of the safety, and the discharge capacity of the positive electrode active material is reduced.

Also, a lithium complex oxide particle having a structure of a spinel type expressed by an average composition represented by the following formula (2) can be used.

LiₕMn₂₋ᵢM2ᵢOⱼ (2)

In the formula (2), M2 is at least one member selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). h, i and j are values falling within the ranges of (0.9≦h≦1.1), (0≦i≦0.6) and (3.7≦j≦4.1), respectively. The composition of lithium varies depending upon the charge/discharge state, and the value of h represents a value in a completely discharged state.

A lithium complex oxide containing nickel as a main component is especially preferable as the lithium complex oxide. What nickel is contained as the main component means that among the metal elements (exclusive of lithium) constituting the lithium complex oxide, a nickel component is contained in the largest proportion. The lithium complex oxide containing nickel as a main component is, for example, one represented by the formula (1) in which the nickel component is contained in a larger proportion that the cobalt component, and an average composition thereof is represented by the following formula (3) wherein the range of c is in the range of (0.5≦c≦1.0).

LiₐCo_{b}Ni_{c}M1_{1-b-c}O_{d} (3)

In the formula (3), M1 is at least one element selected from the group consisting of boron (B), magnesium (Mg), aluminum (Al), silicon (Si), phosphorus (P), sulfur (S), titanium (Ti), chromium (Cr), manganese (Mn), iron (Fe), copper (Cu), zinc (Zn), gallium (Ga), germanium (Ge), yttrium (Y), zirconium (Zr), molybdenum (Mo), silver (Ag), barium (Ba), tungsten (W), indium (In), tin (Sn), lead (Pb) and antimony (Sb). a, b, c and d are values falling within the ranges of (0.2≦a≦1.4), (0≦b≦0.5), (0.5≦c≦1.0) and (1.8≦d≦2.2), respectively. The composition of lithium varies depending upon the charge/discharge state, and the value of a represents a value in a completely discharged state.

The lithium complex oxide whose average composition is represented by the formula (3) is a lithium complex oxide for lithium ion secondary batteries, which is able to realize a high voltage and a high energy density substantially equal to those in a lithium complex oxide containing cobalt as a main component.

As compared with the lithium complex oxide containing cobalt as a main component, the lithium complex oxide containing nickel as a main component is high in economy because a content of cobalt which is instable in natural resources and expensive is small. Furthermore, as compared with the lithium complex oxide containing cobalt as a main component, the lithium complex oxide containing nickel as a main component has such an advantage that its battery capacity is large, and an increase of such an advantage is desired.

Meanwhile, in a secondary battery using, as a positive electrode active material, a lithium complex oxide containing nickel as a main component, there is encountered such a problem that an increase of an internal pressure following the gas generation in the inside of the battery is caused. Then, in the case of using a laminated film for a package member of the secondary battery, there is involved such a problem that blister of the battery is easily generated following the gas generation in the inside of the battery. Thus, it is demanded to solve these problems.

Furthermore, in the first embodiment, a positive electrode active material having an olivine type crystal structure represented by the following formula (4) may be used.

LiₐMn_{b}Fe_{c}M_{d}PO₄ (4)

In the formula (4), a, b, c and d are values within the ranges of (0≦a≦2), ((b+c+d)≦1), (0≦b≦1), (0≦c≦1) and (0≦d≦1). M is at least one member selected from the group consisting of magnesium (Mg), nickel (Ni), cobalt (Co), aluminum (Al), tungsten (W), niobium (Nb), titanium (Ti), silicon (Si), chromium (Cr), copper (Cu) and zinc (Zn).

A thickness of the positive electrode 13 is preferably not more than 250 μm.

[Suppression of the Gas Generation]

Here, for the purpose of making it easy to understand the first embodiment, mechanisms of the gas generation and suppression of the gas generation obtained as a result of extensive and intensive investigations made by the inventors are described.

With respect to the participation of the positive electrode active material in the gas generation of the nonaqueous electrolyte battery, it is a common view that the following Factor 1 and Factor 2 are a cause.

(Factor 1)

A carbonic acid root contained in the positive electrode active material produces a carbonic acid gas by an acid component derived from a nonaqueous electrolytic solution.

(Factor 2)

An organic component of a nonaqueous electrolytic solution or the like is oxidized by a strong oxidizing power of the positive electrode active material in a charged state, thereby producing a carbonic acid gas or carbon monoxide.

Then, it may be considered that suppression of the gas generation can be achieved by obtaining not only an effective treatment for lowering the content of a carbonic acid root of the positive electrode active material but an effective treatment for suppressing an oxidation activity of the surface of the positive electrode active material by a surface treatment of the positive electrode active material. In the correspondence of the amount of the residual carbonic acid root to the blister, there has hitherto been suggested a tendency that in a system where the amount of the residual carbonic acid root is large, the blister is large, whereas in a system where the amount of the residual carbonic acid root is small, the blister is small.

In the first embodiment, there has been obtained a tendency that even when the amount of the residual carbonic acid root is somewhat large, the blister is not directly reflected thereby. This has suggested that so far as the residual carbonic acid root is not always decomposed to produce CO₂ and is able to sufficiently suppress oxidation of an organic component of the nonaqueous electrolytic solution or the like, the blister can be suppressed as a whole. Needless to say, even in the first embodiment, in order to suppress the blister, it is more preferable that the content of the residual carbonic acid root of the positive electrode is small.

[Particle Size]

An average particle size of the positive electrode active material is preferably 2.0 μm or more and not more than 50 μm. When the average particle size of the positive electrode active material is less than 2.0 μm, during pressing a positive electrode active material layer at the time of fabricating a positive electrode, the positive electrode active material layer is separated. Also, since a surface area of the positive electrode active material increases, it is necessary to increase an addition amount of a conductive agent or a binder, and therefore, an energy density per unit weight tends to become small. On the other hand, when this average particle size exceeds 50 μm, there is a tendency that the particle penetrates through the separator, thereby causing a short circuit.

[Negative Electrode]

The negative electrode 14 has, for example, a negative electrode collector 14A and a negative electrode active material layer 14B provided on the both surfaces of this negative electrode collector 14A. For the negative electrode collector 14A, for example, a metal foil such as a copper foil can be used. At least a part of the surface of the negative electrode contains an amorphous polyacid and/or polyacid compound containing one or more kinds of a polyelement, and the amorphous polyacid and/or polyacid compound contains an electrolytic solution to form a gel.

The negative electrode active material layer 14B is, for example, constituted so as to contain, as the negative electrode active material, one or two or more kinds of a negative electrode material capable of intercalating and deintercalating lithium and may further contain a conductive assistant and a binder, if desired.

Examples of the negative electrode material capable of intercalating and deintercalating lithium include carbon materials such as graphite, hardly graphitized carbon and easily graphitized carbon. Such a carbon material may be used singly or in admixture of two or more kinds thereof. Also, a mixture of two or more kinds of carbon materials having a different average particle size from each other may be used.

Also, examples of the negative electrode material capable of intercalating and deintercalating lithium include materials containing, as a constituent element, a metal element or a semi-metal element capable of forming an alloy together with lithium. Specific examples thereof include a simple substance, an alloy or a compound of a metal element capable of forming an alloy together with lithium; a simple substance, an alloy or a compound of a semi-metal element capable of forming an alloy together with lithium; and a material having one or two or more kinds of a phase in at least a part thereof.

Examples of such a metal element or semi-metal element include tin (Sn), lead (Pb), aluminum, indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y) and hafnium (Hf). Above all, a metal element or a semi-metal element belonging to the Group 14 of the long form of the periodic table is preferable; and silicon (Si) and tin (Sn) are especially preferable. This is because silicon (Si) and tin (Sn) have large capability to intercalate and deintercalate lithium and are able to obtain a high energy density.

Examples of alloys of silicon (Si) include alloys containing, as a second constituent element other than silicon (Si), at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of tin (Sn) include alloys containing, as a second constituent element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of silicon (Si) or compounds of tin (Sn) include compounds containing oxygen (O) or carbon (C), and these compounds may further contain the foregoing second constituent element in addition to silicon (Si) or tin (Sn).

[Negative Electrode Coating Film]

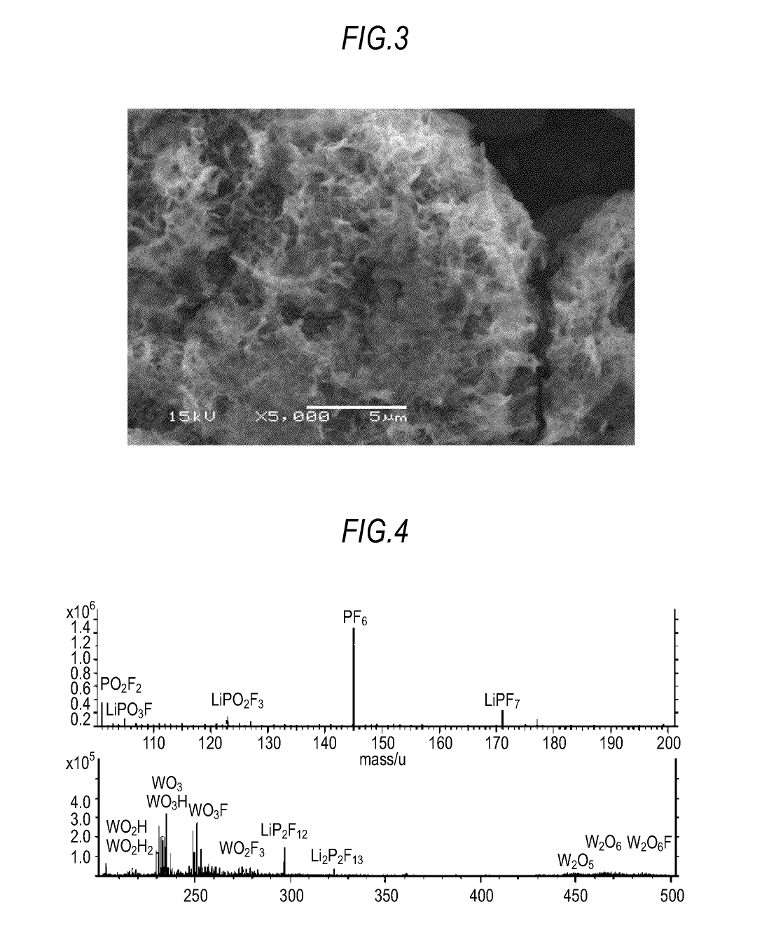

The coating film in a gel form formed on a negative electrode surface according to the first embodiment, which contains an amorphous polyacid and/or polyacid compound containing one or more kinds of a polyelement, can be, for example, confirmed by SEM (scanning electron microscope) as shown in FIG. 3. FIG. 3 is an SEM image of the negative electrode surface after charge and is a photograph taken after washing the electrolytic solution and then drying.

As shown in FIG. 3, the coating film has a three-dimensional network structure. The network structure absorbs the electrolyte to swell and makes the coating film in a gel form.

Also, the deposition of the amorphous polyacid and/or polyacid compound can be confirmed on the basis of structural analysis of the coating film formed on the negative electrode surface by the X-ray absorption fine structure (XAFS) analysis and chemical information of a molecule by the time-of-flight secondary ion mass spectrometry (ToF-SIMS).

FIG. 4 shows an example of a secondary ion spectrum by the time-of-flight secondary ion mass spectrometry (ToF-SIMS) on the negative electrode surface of the nonaqueous electrolyte battery in which the negative electrode coating film according to the first embodiment is formed by adding silicotungstic acid into a battery system and charging the battery. It is noted from FIG. 4 that a molecule containing, as constituent elements, tungsten (W) and oxygen (O) is existent.

Also, FIG. 5 shows an example of a radial structure function of a W—O bond obtained by the Fourier transformation of a spectrum by the X-ray absorption fine structure (XAFS) analysis on the negative electrode surface of the nonaqueous electrolyte battery in which the negative electrode coating film according to the first embodiment is formed by adding silicotungstic acid into a battery system and charging the battery. Also, FIG. 5 shows an example of a radial structure function of a W—O bond of each of tungstic acid (WO₃ or WO₂) as a polyacid which can be used in the first embodiment and silicotungstic acid (H₄(SiW₁₂O₄₀).26H₂O) as a heteropolyacid which can be used in the first embodiment, along with the analysis results of the negative electrode coating film.

It is noted from FIG. 5 that a peak L1 of a deposit on the negative electrode surface has peaks at a different position from peaks L2, L3 and L4 of silicotungstic acid (H₄(SiW₁₂O₄₀).26H₂O), tungsten dioxide (WO₂) and tungsten trioxide (WO₃), respectively and has a different structure. In tungsten trioxide (WO₃) and tungsten dioxide (WO₂), both of which are a typical tungsten oxide, and silicotungstic acid (H₄(SiW₁₂O₄₀).26H₂O) which is a starting material of the first embodiment, in view of the radical structure function, main peaks are existent in the range of from 1.0 to 2.0 angstroms, and peaks can also be confirmed in the range of from 2.0 to 4.0 angstroms.

On the other hand, in the distribution of the W—O bond distance of the polyacid composed mainly of tungstic acid deposited on each of the positive electrode and the negative electrode in the first embodiment, though the peaks are confirmed within the range of from 1.0 to 2.0 angstroms, distinct peaks equivalent to those in the peak L1 are not found in the outside of the foregoing range. That is, no peak is substantially observed in the range exceeding 3.0 angstroms. In such a situation, it is confirmed that the deposit on the negative electrode surface is amorphous.

In the first embodiment, the coating film in a gel form containing an amorphous polyacid and/or polyacid compound containing one or more kinds of a polyelement is formed on the surface of the negative electrode 14 by charge or preliminary charge. Then, a part of at least one of the polyacid and the polyacid compound is reduced, whereby the valence of the polyatom ion becomes less than 6. Meanwhile, at least one of the polyacid and the polyacid compound existing without being reduced and with a valence of 6 in terms of a polyatom ion is also existent at the same time.

For example, when the polyatom of each of the polyacid and the polyacid compound on the surface of the negative electrode 14 is tungsten, each of the polyacid and the polyacid compound is existent while containing both a tungsten ion with a valence of less than 6 and a tungsten ion with a valence of 6. Similarly, when the polyatom of each of the polyacid and the polyacid compound on the surface of the negative electrode 14 is, for example, molybdenum, each of the polyacid and the polyacid compound is existent while containing both a molybdenum ion with a valence of less than 6 and a molybdenum ion with a valence of 6.

In the light of the above, in view of the fact that a polyatom ion in a reduced state and a polyatom ion in a non-reduced state are mixed and existent, it is expected that the stability of each of the polyacid and the polyacid compound having a gas absorbing effect increases, so that the tolerance to the electrolyte is enhanced.

In the first embodiment, for example, the heteropolyacid is converted to a polyacid compound having poorer solubility than the heteropolyacid by charge or preliminary charge, whereby it is existent on the surface of the positive electrode 14. Then, there may be the case where the heteropolyacid is reduced and converted to a polyacid compound having poorer solubility than the heteropolyacid by charge or preliminary charge, whereby it is existent on the surface of the negative electrode 14. Also, at least one of the foregoing polyacid and polyacid compound may be contained in the negative electrode active material layer 14B, namely among the negative electrode active material particles.

The presence or absence of the deposition of at least one of the polyacid and the polyacid compound can be confirmed by disassembling a nonaqueous electrolyte battery 20 after charge or preliminary charge and taking out the negative electrode 14. For example, when as a result of confirming a composition of the deposit deposited on the negative electrode collector 14A, and at least one of the polyacid and the polyacid compound is deposited, it can be easily supposed that at least one of the polyacid and the polyacid compound is deposited is similarly deposited on the negative electrode active material layer 14B.

The reduced state of at least one of the deposited polyacid and polyacid compound can be confirmed by the X-ray photoelectron spectroscopy (XPS) analysis. In that case, the battery is disassembled, followed by washing with dimethyl carbonate. This is made for the purpose of removing a solvent component with low volatility and an electrolyte salt existing on the surface. It is desirable that sampling is carried out in an inert atmosphere if it is at all possible. Also, when there is a doubt as to the superimposition of peaks assigned to plural energies, by subjecting the measured spectrum to wave analysis to separate the peaks, it is possible to determine the presence or absence of peaks assigned to tungsten or molybdenum ions with valences of 6 and less than 6.

By depositing at least one of such polyacid and polyacid compound on the surface of the negative electrode 14, it is possible to prevent the matter that a large current abruptly flows due to the contact between the positive electrode 13 and the negative electrode 14 from occurring and to suppress the momentary heat generation of the secondary battery. It may be considered that this is caused due to the fact that the strength of the separator 15 coming into close contact with the negative electrode 14 is increased by at least one of the polyacid and the polyacid compound deposited on the surface of the negative electrode 14.

Also, at least one of such polyacid and polyacid compound is deposited on the surface of the negative electrode 14 in such a manner that a polyatom ion, for example, a tungsten or molybdenum ion is existent so as to have plural valences of 6 and less than 6. According to this, it is possible to suppress the blister of the nonaqueous electrolyte battery 20 to be caused due to the gas generation on the surface of the active material, or on the surface of at least one of the deposited polyacid and polyacid compound. It may be considered that this is caused due to the fact that at least one of the polyacid and the polyacid compound in a non-reduced state sufficiently covers the surface of the negative electrode active material, so that the generation of a gas such as carbon dioxide (CO₂) to be caused due to a decomposition reaction of the electrolyte is suppressed.

[Separator]

Any material may be used for the separator 15 so far as it is electrically stable and chemically stable against the positive electrode active material, the negative electrode active material or the solvent and does not have electrical conductivity. For example, a non-woven fabric of a polymer, a porous film or a material prepared by processing glass or ceramic fibers into a paper form can be used, and a laminate made of a plurality of these materials may be used. In particular, it is preferable to use a porous polyolefin film. Such a porous polyolefin film may be complexed with a heat-resistant material such as polyimides and glass or ceramic fibers.

[Electrolyte]

The electrolyte 16 contains an electrolytic solution and a holding material containing a polymer compound capable of holding this electrolytic solution therein and is prepared in a so-called gel form. The electrolytic solution contains an electrolyte salt and a solvent for dissolving this electrolyte salt therein. Examples of the electrolyte salt include lithium salts such as LiPF₆, LiClO₄, LiBF₄, LiN(SO₂CF₃)₂, LiN(SO₂C₂F₅)₂ and LiAsF₆. The electrolyte salt may be used singly or in admixture of two or more kinds thereof. Then, silicotungstic acid and/or a silicotungstic acid compound is added to this electrolytic solution in a state before charging the nonaqueous electrolyte battery 20.

Examples of the solvent include nonaqueous solvents, for example, lactone based solvents such as γ-butyrolactone, γ-valerolactone, δ-valerolactone and ε-caprolactone; carbonate based solvents such as ethylene carbonate, propylene carbonate, butylene carbonate, vinylene carbonate, dimethyl carbonate, ethyl methyl carbonate and diethyl carbonate; ether based solvents such as 1,2-dimethoxyethane, 1-ethoxy-2-methoxyethane, 1,2-diethoxyethane, tetrahydrofuran and 2-methyltetrahydrofuran; nitrile based solvents such as acetonitrile; sulfolane based solvents; phosphoric acids; and phosphate solvents; pyrrolidones. The solvent may be used singly or in admixture of two or more kinds thereof.

Also, it is preferable that the solvent contains a compound obtained by fluorinating a part or the whole of hydrogens of a cyclic ester or a chain ester. As such a fluorinated compound, it is preferable to use difluoroethylene carbonate (4,5-difluoro-1,3-dioxolan-2-one). This is because even when the negative electrode 14 containing, as a negative electrode active material, a compound of silicone (Si), tin (Sn), germanium (Ge) or the like is used, a charge/discharge cycle characteristic can be enhanced, and in particular, difluoroethylene carbonate is excellent in an effect for improving the cycle characteristic.

Any material is useful as the polymer compound so far as it is gelated upon absorbing the solvent therein. Examples thereof include fluorocarbon based polymer compounds such as polyvinylidene fluoride and a copolymer of vinylidene fluoride and hexafluoropropylene; ether based polymer compounds such as polyethylene oxide and a crosslinked material containing polyethylene oxide; and compounds containing, as a repeating unit, polyacrylonitrile, polypropylene oxide or polymethyl methacrylate. The polymer compound may be used singly or in admixture of two or more kinds thereof.

In particular, from the standpoint of oxidation-reduction stability, fluorocarbon based polymer compounds are desirable; and above all, a copolymer containing, as components, vinylidene fluoride and hexafluoropropylene is preferable. Furthermore, this copolymer may contain, as a component, a monoester of an unsaturated dibasic acid such as monomethyl maleate, a halogenated ethylene such as trifluorochloroethylene, a cyclic carbonate of an unsaturated compound such as vinyl carbonate, an epoxy group-containing acryl vinyl monomer or the like. This is because higher characteristics are obtainable.

Furthermore, in order to deposit at least one of the polyacid and the polyacid compound on the surface of the negative electrode 14, at least one of a polyacid and a polyacid compound, and preferably at least one of a heteropolyacid and a heteropolyacid compound is previously added to the electrolytic solution. By charge or preliminary charge after fabricating the nonaqueous electrolyte battery 20, it is possible to deposit the polyacid or polyacid compound on the surface of the negative electrode 14.

[Polyacid and Polyacid Compound]

The polyacid as referred to herein means a condensate of an oxoacid. It is preferable that this polyacid or polyacid compound has a structure in which a polyacid ion thereof is easily soluble in the solvent of the battery, such as a Keggin structure, an Anderson structure and a Dawson structure.

Similar to a heteropolyacid and/or a heteropolyacid compound, the polyacid and/or the polyacid compound according to the first embodiment is one having a polyatom selected from the following element group (a); or one having a polyatom selected from the following element group (a), in which a part of the polyatoms is substituted with at least any one element selected from the following element group (b).

Element group (a): Mo, W, Nb, V

Element group (b): Ti, Cr, Mn, Fe, Co, Ni, Cu, Zn, Ga, Zr, Tc, Rh, Cd, In, Sn, Ta, Re, Tl, Pb

Examples of the polyacid which is used in the first embodiment include tungstic(VI) acid and molybdic(VI) acid. Specific examples thereof include tungstic anhydride and molybdic anhydride and hydrates thereof. Examples of the hydrate which can be used include orthotungstic acid (H₂WO₄) which is tungstic acid monohydrate (WO₃.H₂O), molybdic acid dihydrate (H₄MoO₅, H₂MoO₄.H₂O or MoO₃.2H₂O) and orthomolybdic acid (H₂MoO₄) which is molybdic acid monohydrate (MoO₃.H₂O). Also, tungstic anhydride (WO₃) having a smaller hydrogen content than metatungstic acid, paratungstic acid and the like which are an isopolyacid of the foregoing hydrate, and ultimately having a zero hydrogen content; molybdic anhydride (MoO₃) having a smaller hydrogen content than metamolybdic acid, paramolybdic acid and the like, and ultimately having a zero hydrogen content; and the like can be used.

[Heteropolyacid and Heteropolyacid Compound]

The heteropolyacid as referred to herein means a condensate of two or more oxoacids having a hetero atom. It is preferable that this heteropolyacid or heteropolyacid compound has a structure in which a heteropolyacid ion thereof is easily soluble in the solvent of the battery, such as a Keggin structure, an Anderson structure and a Dawson structure.

The heteropolyacid and/or the heteropolyacid compound is one having a polyatom selected from the following element group (a); or one having a polyatom selected from the following element group (a), in which a part of the polyatoms is substituted with at least any one element selected from the following element group (b).

Element group (a): Mo, W, Nb, V

Element group (b): Ti, Cr, Mn, Fe, Co, Ni, Cu, Zn, Ga, Zr, Tc, Rh, Cd, In, Sn, Ta, Re, Tl, Pb

Also, the heteropolyacid and/or the heteropolyacid compound is one having a hetero atom selected from the following element group (c); or one having a hetero atom selected from the following element group (c), in which a part of the hetero atoms is substituted with at least any one element selected from the following element group (d).

Element group (c): B, Al, Si, P, Cr, Mn, Fe, Co, Ni, Cu, Zn, Ge, As

Element group (d): H, Be, B, C, Na, Al, Si, P, S, Ti, V, Cr, Mn, Fe, Co, Ni, Cu, Zn, Ga, Ge, As, Se, Zr, Rh, Sn, Sb, Te, I, Re, Pt, Bi, Ce, Th, U, Np

Examples of the heteropolyacid which is used in the first embodiment include heteropolytungstic acids such as phosphotungstic acid and silicotungstic acid; and heteropolymolybdic acids such as phosphomolybdic acid and silicomolybdic acid.

Also, as a material containing plural polyatoms, materials such as phosphovanadomolybdic acid, phosphotungstomolybdic acid, silicovanadomolybdic acid and silicotungstomolybdic acid can be used.

It is preferable that the heteropolyacid compound has a cation, for example, Li⁺, Na⁺, K⁺, Rb⁺, Cs⁺, R₄N⁺, R₄P⁺, etc., wherein R is H or a hydrocarbon group having not more than 10 carbon atoms. Also, the cation is more preferably Li⁺, tetra-n-butylammonium or tetra-n-butylphosphonium.

Examples of such a heteropolyacid compound include heteropolytungstic acid compounds such as sodium silicotungstate, sodium phosphotungstate, ammonium phosphotungstate and a silicotungstic acid tetra-tetra-n-butylphosphonium salt. Also, examples of the heteropolyacid compound include heteropolymolybdic acid compounds such as sodium phosphomolybdate, ammonium phosphomolybdate and a phosphomolybdic acid tri-tetra-n-butylammonium salt. Furthermore, examples of a compound containing plural polyacids include materials such as a phosphotungstomolybdic acid tri-tetra-n-ammonium salt. Such a heteropolyacid or heteropolyacid compound may be used in admixture of two or more kinds thereof. Such a heteropolyacid or heteropolyacid compound is easily soluble in the solvent, is stable in the battery and is hard to give adverse influences such as a reaction with other material.

It is preferable to use the heteropolyacid and/or the heteropolyacid compound because it exhibits high solubility in a solvent to be used at the time of preparing a positive electrode mixture or a negative electrode mixture and a nonaqueous solvent to be used for the electrolyte, and the like. Also, the hetero atom-free polyacid and/or polyacid compound tends to be slightly inferior in an effect per the addition weight to the heteropolyacid and/or the heteropolyacid compound. However, since the hetero atom-free polyacid and/or polyacid compound is low in solubility in a polar solvent, when applied to the positive electrode or negative electrode, it is excellent in coating viscoelasticity and coating characteristics such as change of coating viscoelasticity with time. Therefore, the hetero atom-free polyacid and/or polyacid compound is useful from the industrial viewpoint.

(1-2) Manufacturing Method of Nonaqueous Electrolyte Battery

A method for manufacturing the nonaqueous electrolyte battery according to the first embodiment is hereunder described.

[Manufacturing Method of Positive Electrode]

The positive electrode 13 is manufactured in the following manner. First of all, a positive electrode active material, a binder and a conductive assistant such as carbon materials are mixed to prepare a positive electrode mixture, and this positive electrode mixture is dispersed in a solvent such as N-methyl-2-pyrrolidone to prepare a positive electrode mixture slurry. As the binder, polyvinylidene fluoride, polytetrafluoroethylene or the like is useful.

Subsequently, this positive electrode mixture slurry is coated on the positive electrode collector 13A and dried, and the resultant is then compression molded by a roll press or the like to form the positive electrode active material layer 13B. There is thus obtained the positive electrode 13. The conductive assistant such as carbon materials is mixed on the occasion of preparing the positive electrode mixture, as the need arises.

[Manufacturing Method of Negative Electrode]

Next, the negative electrode 14 is fabricated in the following manner. First of all, a negative electrode active material and a binder are mixed to prepare a negative electrode mixture, and this negative electrode mixture is dispersed in a solvent such as N-methyl-2-pyrrolidone, thereby preparing a negative electrode mixture slurry. Subsequently, this negative electrode mixture slurry is coated on the negative electrode collector 14A, and after drying the solvent, the resultant is compression molded by a roll press or the like to form the negative electrode active material layer 14B. There is thus obtained the negative electrode 14.

[Assembling Method of Nonaqueous Electrolyte Battery]

This nonaqueous electrolyte battery can be, for example, manufactured in the following manner. First of all, a precursor solution containing an electrolytic solution having at least one of a heteropolyacid and a heteropolyacid compound added thereto, a polymer compound and a mixed solvent is coated on each of the positive electrode 13 and the negative electrode 14, and the mixed solvent is volatilized to form the electrolyte 16. Thereafter, the positive electrode lead 11 is installed in an end of the positive electrode collector 13A by means of welding, and the negative electrode lead 12 is also installed in an end of the negative electrode collector 14A by means of welding.

At that time, it is preferable that the heteropolyacid and/or the heteropolyacid compound is added in an amount of 0.01% by weight or more and not more than 5.0% by weight based on 100% by weight of the negative electrode active material. When the heteropolyacid and/or the heteropolyacid compound is added in an excessive amount falling outside the foregoing range, the discharge capacity of the nonaqueous electrolyte battery 20 is lowered. On the other hand, when the heteropolyacid and/or the heteropolyacid compound is added in an extremely small amount falling outside the foregoing range, the blister suppressing effect and safety of the nonaqueous electrolyte battery aimed according to the first embodiment are not obtainable.

Subsequently, the positive electrode 13 and the negative electrode 14 each having the electrolyte 16 formed thereon are laminated via the separator 15, the laminate is then wound in a longitudinal direction thereof, and the protective tape 17 is allowed to adhere to an outermost peripheral part thereof, thereby forming the wound electrode body 10. Finally, for example, the wound electrode body 10 is interposed between the package members 1, and the outer edges of the package members 1 are brought into close contact with each other by means of heat fusion or the like and sealed. On that occasion, the contact film 2 is inserted between each of the positive electrode lead 11 and the negative electrode lead 12 and the package member 1. There is thus completed the nonaqueous electrolyte battery shown in FIGS. 1 and 2.

Also, this nonaqueous electrolyte battery may be fabricated in the manner described above. First of all, as described previously, the positive electrode 13 and the negative electrode 14 are fabricated; and the positive electrode lead 11 and the negative electrode lead 12 are installed in the positive electrode 13 and the negative electrode 14, respectively. The positive electrode 13 and the negative electrode 14 are then laminated via the separator 15 and wound, and the protective tape 17 is allowed to adhere to the outermost peripheral part of the wound laminate, thereby forming a wound electrode body as a precursor of the wound electrode body 10. Subsequently, this wound electrode body 10 is interposed into the package member 1, and the outer edges exclusive of one side are subjected to heat fusion to form a bag, which is then housed in the inside of the package member 1. Subsequently, an electrolyte composition containing an electrolytic solution, a monomer as a raw material of a polymer compound, a polymerization initiator and optionally, other materials such as a polymerization inhibitor is prepared and injected into the inside of the package member 1.

After the electrolyte composition is injected, an opening of the package member 1 is hermetically sealed by means of heat fusion in a vacuum atmosphere. Subsequently, the monomer is polymerized upon heating to prepare a polymer compound, thereby forming the electrolyte 16 in a gel form; and the nonaqueous electrolyte battery shown in FIGS. 1 and 2 is assembled.

By charging or preliminarily charging the fabricated battery, the nonaqueous electrolyte battery 20 according to the first embodiment, in which at least one of the polyacid and the polyacid compound is deposited on the surface of the negative electrode 14, is completed. As described in detail in the working examples, when at least one of a heteropolyacid and a heteropolyacid compound is not added to the electrolytic solution, no deposit is confirmed. For that reason, it may be considered that the deposit deposited on the negative electrode is one derived from at least one of the heteropolyacid and a heteropolyacid compound.

[Effect]

According to the nonaqueous electrolyte battery of the first embodiment, the gas generation in the inside of the battery can be reduced. Also, since the gas generation in the inside of the battery can be reduced, blister of the battery can be suppressed.

### 2. Second Embodiment

In the nonaqueous electrolyte battery 20 according to the second embodiment, at least one of a heteropolyacid and a heteropolyacid compound is deposited on not only the surface of the negative electrode 14 but the surface of the positive electrode 13, and a deposit on the surface of the positive electrode 13 is in a more oxidized state as compared with that on the surface of the negative electrode 14.

[Positive Electrode]

The positive electrode 13 has, for example, the positive electrode collector 13A and the positive electrode active material layer 13B provided on the both surfaces of this positive electrode collector 13A. For the positive electrode collector 13A, for example, a metal foil such as an aluminum foil can be used. The positive electrode active material layer 13B contains a positive electrode active material, a conductive assistant such as carbon materials and a binder such as polyvinylidene fluoride and polytetrafluoroethylene. This configuration is the same as that in the first embodiment.

Similar to the first embodiment, in the second embodiment, at least one of a polyacid and a polyacid compound is deposited on the surface of the negative electrode 14. Also, a part of at least one of the deposited polyacid and polyacid compound is reduced, whereby the valence of the polyatom ion becomes less than 6. Meanwhile, at least one of the polyacid and the polyacid compound existing without being reduced and with a valence of 6 in terms of a polyatom ion is also existent at the same time.

Also, at least one of a polyacid and a polyacid compound is deposited on the surface of the positive electrode 13. Then, a polyacid atom ion of the deposited polyacid and/or the polyacid compound deposited on the surface of the positive electrode 13 is in an oxidized state as compared with the polyatom ion contained in at least one of the polyacid acid and polyacid compound deposited on the negative electrode 14. That is, an average valence of the polyacid atom ion of the polyacid and/or the polyacid compound deposited on the surface of the positive electrode 13 is larger than an average valence of the polyatom ion contained in at least one of the polyacid and the polyacid compound deposited on the negative electrode 14.

[Effect]

According to the second embodiment, the gas generation can be lowered by providing the negative electrode 14 on which a polyacid and/or a polyacid compound containing polyatom ions in a non-reduced state and a reduced state is deposited and the positive electrode 13 on which a polyacid and/or a polyacid compound containing a polyatom ion in a more oxidized state as compared with the deposit on the negative electrode 14.

### 3. Third Embodiment

The nonaqueous electrolyte battery 20 according to the third embodiment has higher safety in view of the fact that the negative electrode 14 and the separator 15 are immobilized by deposits.

In the nonaqueous electrolyte battery 20 according to the third embodiment, the wound electrode body 10 of a flat type is fabricated and packaged by the package member 1 in the same manner as in the first embodiment. Thereafter, for example, the nonaqueous electrolyte battery 20 can be manufactured by stamping from the top surface and bottom surface of the wound electrode body 10 and by performing preliminary charge in a state where the nonaqueous electrolyte battery 20 does not expand at the time of charge. The negative electrode 14 and the separator 15 are more firmly immobilized by performing preliminary charge while stamping from the outside. For that reason, the contraction of the separator 15 occurs more hardly. Similar to the first embodiment, the deposit deposited on the negative electrode 14 is one resulting from electrolysis of at least one of a heteropolyacid and a heteropolyacid compound.

[Effect]

According to the third embodiment, the contraction of the separator 15 can be suppressed due to the fact that the negative electrode 14 and the separator 15 are immobilized with the deposited polyacid and/or polyacid compound. According to this, even when the battery causes abnormal heat generation, it is possible to prevent the matter that a large current abruptly flows due to the contact between the positive electrode 13 and the negative electrode 14 from occurring and to suppress the momentary heat generation of the nonaqueous electrolyte battery 20. Also, the gas generation can be suppressed by the heteropolyacid and/or the heteropolyacid compound deposited on the negative electrode surface according to the third embodiment.

### 4. Fourth Embodiment

A nonaqueous electrolyte battery 20 according to a fourth embodiment uses an electrolytic solution in place of the electrolyte 16 in a gel form in the nonaqueous electrolyte battery 20 according to the first embodiment. In that case, the electrolytic solution is impregnated in the separator 15. The same material as that in the first embodiment can be used as the electrolytic solution.

The nonaqueous electrolyte battery 20 having such a configuration can be, for example, fabricated in the following manner. First of all, the positive electrode 13 and the negative electrode 14 are fabricated. Since the fabrication of each of the positive electrode 13 and the negative electrode 14 is the same as that in the first embodiment, its detailed description is omitted.

Subsequently, the positive electrode lead 11 and the negative electrode lead 12 are installed in the positive electrode 13 and the negative electrode 14, respectively. The positive electrode 13 and the negative electrode 14 are then laminated via the separator 15 and wound, and the protective tape 17 is allowed to adhere to the outermost peripheral part of the wound laminate.

According to this, in the configuration of the wound electrode body 10, a wound electrode body having a configuration in which the electrolyte 16 is omitted is obtained. This wound electrode body is interposed into the package member 1, and the electrolytic solution is then injected, followed by hermetically sealing the package member 1. By charging or preliminarily charging the fabricated battery, the nonaqueous electrolyte battery 20 according to the fourth embodiment, in which at least one of the polyacid and the polyacid compound is deposited on the surface of the negative electrode 14, is completed.

[Effect]

According to the fourth embodiment, the same effects as those in the first embodiment can be obtained. That is, according to the fourth embodiment, the gas generation of the electrolytic solution can be suppressed, and the blister of the battery can be suppressed.

### 5. Fifth Embodiment

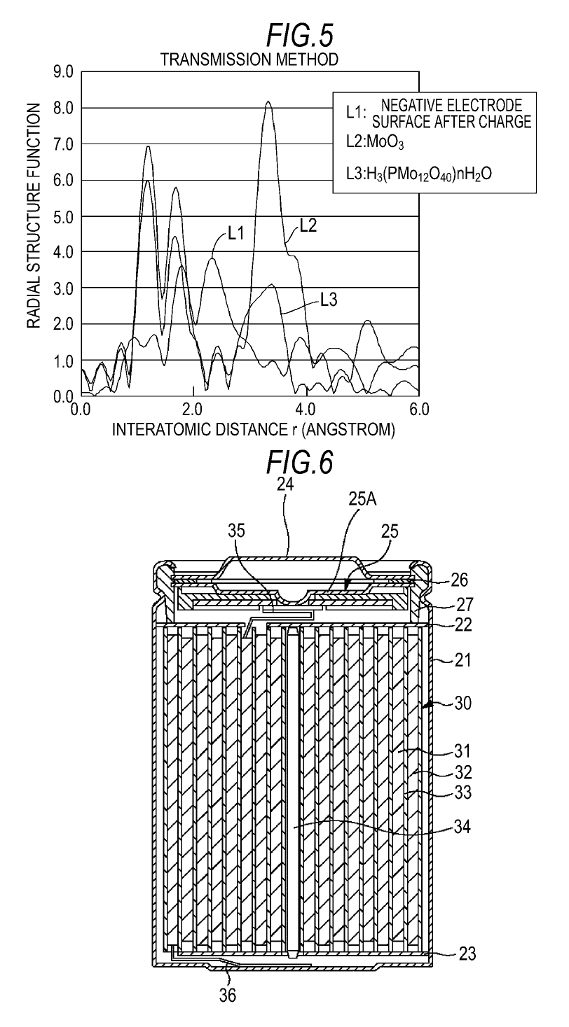

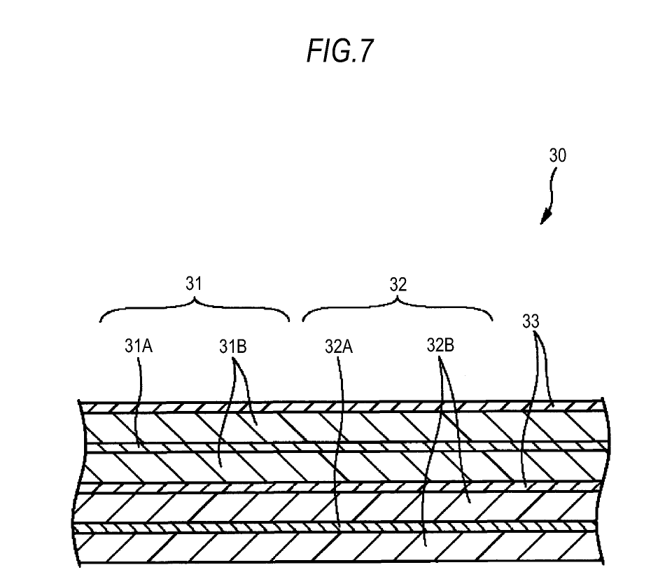

Next, a configuration of the nonaqueous electrolyte battery 20 according to a fifth embodiment is described by reference to FIGS. 6 to 7. FIG. 6 shows a configuration of the nonaqueous electrolyte battery 20 according to the fifth embodiment.

(5-1) Configuration of Nonaqueous Electrolyte Battery

This nonaqueous electrolyte battery 20 is of a so-called cylindrical type and has a wound electrode body 30 having a strip-shaped positive electrode 31 and a strip-shaped negative electrode 32 wound via a separator 33 in the inside of a substantially hollow columnar battery can 21.

The separator 33 is impregnated with an electrolytic solution which is a liquid electrolyte. The battery can 21 is constituted of, for example, iron (Fe) plated with nickel (Ni), and one end thereof is closed, with the other end being opened. In the inside of the battery can 21, a pair of insulating plates 22 and 23 is respectively disposed vertical to the winding peripheral face so as to interpose the wound electrode body 30 therebetween.

In the open end of the battery can 21, a battery lid 24 is installed by caulking with a safety valve mechanism 25 and a positive temperature coefficient device (PTC device) 26 provided in the inside of this battery lid 24 via a gasket 27, and the inside of the battery can 21 is hermetically sealed.

The battery lid 24 is, for example, constituted of the same material as that in the battery can 21. The safety valve mechanism 25 is electrically connected to the battery lid 24 via the positive temperature coefficient device 26. In this safety valve mechanism 25, when the internal pressure of the battery reaches a fixed value or more due to an internal short circuit or heating from the outside or the like, a disc plate 25A is reversed, whereby electrical connection between the battery lid 24 and the wound electrode body 30 is disconnected.

When the temperature rises, the positive temperature coefficient device 26 controls the current by an increase of the resistance value, thereby preventing abnormal heat generation to be caused due to a large current. The gasket 27 is, for example, constituted of an insulating material, and asphalt is coated on the surface thereof.

The wound electrode body 30 is, for example, wound centering on a center pin 34. In the wound electrode body 30, a positive electrode lead 35 made of aluminum (Al) or the like is connected to the positive electrode 31; and a negative electrode lead 36 made of nickel (Ni) or the like is connected to the negative electrode 32. The positive electrode lead 35 is electrically connected to the battery lid 24 by means of welding to the safety valve mechanism 25; and the negative electrode lead 36 is electrically connected to the battery can 21 by means of welding.

FIG. 7 shows enlargedly a part of the wound electrode body 30 shown in FIG. 6. The wound electrode body 30 is one in which the positive electrode 31 and the negative electrode 32 are laminated via the separator 33 and wound.

For example, the positive electrode 31 has a positive electrode collector 31A and a positive electrode active material layer 31B provided on the both surfaces of this positive electrode collector 31A. The negative electrode 32 has a negative electrode collector 32A and a negative electrode active material layer 32B provided on the both surfaces of this negative electrode collector 32A. Configurations of the positive electrode collector 31A, the positive electrode active material layer 31B, the negative electrode collector 32A, the negative electrode active material layer 32B, the separator 33 and the electrolytic solution are the same as those in the positive electrode collector 13A, the positive electrode active material layer 13B, the negative electrode collector 14A, the negative electrode active material layer 14B, the separator 15 and the electrolytic solution in the first embodiment, respectively.

(5-2) Manufacturing Method of Nonaqueous Electrolyte Battery

Next, a method for manufacturing the nonaqueous electrolyte battery 20 according to the fifth embodiment is described. The positive electrode 31 is fabricated in the following manner. First of all, a positive electrode active material and a binder are mixed to prepare a positive electrode mixture, and this positive electrode mixture is dispersed in a solvent such as N-methyl-2-pyrrolidone to prepare a positive electrode mixture slurry. Subsequently, this positive electrode mixture slurry is coated on the positive electrode collector 31A and dried, and the resultant is then compression molded by a roll press or the like to form the positive electrode active material layer 31B. There is thus obtained the positive electrode 31.

The negative electrode 32 is fabricated in the following manner. First of all, a negative electrode active material and a binder are mixed to prepare a negative electrode mixture, and this negative electrode mixture is dispersed in a solvent such as N-methyl-2-pyrrolidone to prepare a negative electrode mixture slurry. Subsequently, this negative electrode mixture slurry is coated on the negative electrode collector 32A and dried, and the resultant is then compression molded by a roll press or the like to form the negative electrode active material layer 32B. There is thus obtained the negative electrode 32.

Subsequently, the positive electrode lead 35 is installed in the positive electrode collector 31A by means of welding or the like, and the negative electrode lead 36 is also installed in the negative electrode collector 32A by means of welding or the like. Thereafter, the positive electrode 31 and the negative electrode 32 are wound via the separator 33; a tip end of the positive electrode lead 35 is welded to the safety valve mechanism 25; and a tip end of the negative electrode lead 36 is also welded to the battery can 21.

Then, the wound positive electrode 31 and negative electrode 32 are interposed between a pair of the insulating plates 22 and 23 and housed in the inside of the battery can 21. After housing the positive electrode 31 and the negative electrode 32 in the inside of the battery can 21, an electrolyte containing at least one of a heteropolyacid and a heteropolyacid compound is injected into the inside of the battery can 21 and impregnated in the separator 33. Since the mixing amount or the like of at least one of the heteropolyacid and the heteropolyacid compound is the same as in the first embodiment, its detail description is omitted.

Thereafter, the battery lid 24, the safety valve mechanism 25 and the positive temperature coefficient device 26 are fixed to the open end of the battery can 21 upon being caulked via the gasket 27. By charging or preliminarily charging the thus fabricated battery, the nonaqueous electrolyte battery 20 according to the fifth embodiment, in which at least one of the polyacid and the polyacid compound is deposited on the surface of the negative electrode 32, is completed.

[Effect]

According to the nonaqueous electrolyte battery 20 of the fifth embodiment, the gas generation can be suppressed, and breakage to be caused due to an increase of the internal pressure can be prevented from occurring.

### 6. Sixth Embodiment

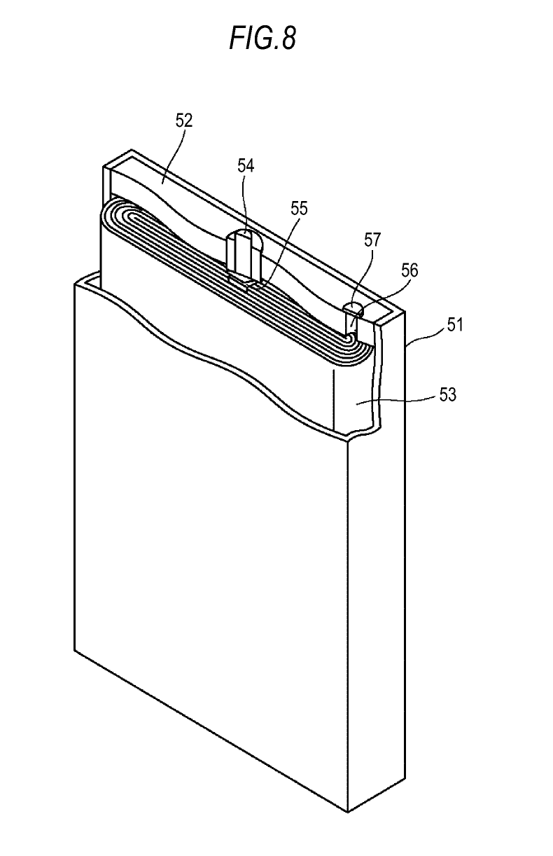

A configuration example of the nonaqueous electrolyte battery 20 according to a sixth embodiment is described. As shown in FIG. 8, the nonaqueous electrolyte battery 20 according to the sixth embodiment has a rectangular shape.

This nonaqueous electrolyte battery 20 is fabricated in the following manner. As shown in FIG. 8, first of all, a wound electrode body 53 is housed in a package can 51 which is a rectangular can made of a metal, for example, aluminum (Al), iron (Fe), etc.

Then, an electrode pin 54 provided on a battery lid 52 and an electrode terminal 55 led out from the wound electrode body 53 are connected to each other, followed by sealing by a battery lid 52. An electrolytic solution is injected from an electrolytic solution injection port 56, followed by sealing by a sealing member 57. By charging or preliminarily charging the fabricated battery, the nonaqueous electrolyte battery 20 according to the sixth embodiment, in which at least one of the polyacid and the polyacid compound is deposited on the surface of the negative electrode 14, is completed.

The wound electrode body 53 is obtained by laminating a positive electrode and a negative electrode via a separator and winding the laminate. Since the positive electrode, the negative electrode, the separator and the electrolytic solution are the same as those in the first embodiment, their detailed descriptions are omitted.

[Effect]

According to the nonaqueous electrolyte battery 20 according to the sixth embodiment, the gas generation of the electrolytic solution can be suppressed, and breakage to be caused due to an increase of the internal pressure can be prevented from occurring.

### 7. Seventh Embodiment

In a seventh embodiment, an example in which a heteropolyacid and/or a heteropolyacid compound is mixed in the negative electrode active material layer 14B but not the electrolyte in the nonaqueous electrolyte battery 20 according to the first embodiment is described. In the seventh embodiment, only points which are different from those in the first embodiment are described.

(7-1) Configuration of Nonaqueous Electrolyte Battery

[Negative Electrode]

The negative electrode active material layer 14B is, for example, constituted so as to contain, as a negative electrode active material, one or two or more kinds of a negative electrode material capable of intercalating and deintercalating lithium and at least one of the foregoing heteropolyacid and heteropolyacid compound, and the negative electrode active material layer 14B may further contain a conductive assistant and a binder, if desired. At least one of the heteropolyacid and the heteropolyacid compound is decomposed by electrolysis. Then, at least one of the polyacid and the polyacid compound, each of which contains both a polyatom ion with a valence of 6 and a polyatom ion with a valence of less than 6, is deposited on the surface of the negative electrode 14. Also, the polyacid and/or the polyacid compound may be contained among the negative electrode active material particles. Also, an optimal range of the deposition amount of the polyacid and/or the polyacid compound is preferably 0.01% by weight or more and not more than 5.0% by weight based on 100% by weight of the negative electrode active material. The deposition amount of the polyacid and/or the polyacid compound can be detected by means of NMR. The weight of the polyacid is defined to be a value obtained by subtracting the weight of bound water which the polyacid has. Also, similarly, the weight of the polyacid compound is defined to be a value obtained by subtracting the weight of bound water which the polyacid compound has.

Similar to the first embodiment, the polyacid or polyacid compound deposited on the surface of the negative electrode 14 can be confirmed by detecting a composition of the deposit deposited on the negative electrode collector 14A. Also, similar to the first embodiment, the reduced state of each of the deposited polyacid and polyacid compound can be confirmed by the X-ray photoelectron spectroscopy (XPS) analysis.

[Electrolyte]

The electrolyte is an electrolytic solution containing an electrolyte salt and a solvent for dissolving this electrolyte salt therein. In the seventh embodiment, at least one of a heteropolyacid and a heteropolyacid compound is not added to the electrolyte.

(7-2) Manufacturing Method of Nonaqueous Electrolyte Battery

A method for manufacturing the nonaqueous electrolyte battery according to the seventh embodiment is hereunder described. In the manufacturing method of the seventh embodiment, the case of using a gel electrolyte is described.

[Manufacturing Method of Negative Electrode]

The negative electrode 14 is fabricated in the following manner. First of all, a negative electrode active material, a binder and optionally, a conductive assistance are mixed. Also, at least one of a heteropolyacid and a heteropolyacid compound is dissolved in a solvent such as N-methyl-2-pyrrolidone to prepare a solution. At that time, it is preferable that the heteropolyacid and/or the heteropolyacid compound is added in an amount of 0.01% by weight or more and not more than 5.0% by weight based on 100% by weight of the negative electrode active material. The weight of the heteropolyacid is defined to be a value obtained by subtracting the weight of bound water which the heteropolyacid has. Also, similarly, the weight of the heteropolyacid compound is defined to be a value obtained by subtracting the weight of bound water which the heteropolyacid compound has. When the heteropolyacid and/or the heteropolyacid compound is added in an excessive amount falling outside the foregoing range, the discharge capacity of the nonaqueous electrolyte battery 20 is lowered. On the other hand, when the heteropolyacid and/or the heteropolyacid compound is added in an extremely small amount falling outside the foregoing range, the blister suppressing effect and safety of the nonaqueous electrolyte battery aimed according to the seventh embodiment are not obtainable.

Subsequently, this solution and the foregoing mixture are mixed to prepare a negative electrode mixture, and this negative electrode mixture is dispersed in a solvent such as N-methyl-2-pyrrolidone, thereby preparing a negative electrode mixture slurry. Subsequently, this negative electrode mixture slurry is coated on the negative electrode collector 14A, and after drying the solvent, the resultant is compression molded by a roll press or the like to form the negative electrode active material layer 14B. There is thus obtained the negative electrode 14.

[Manufacturing Methods of Electrolyte and Nonaqueous Electrolyte Battery]

The electrolyte is prepared in the following manner. First of all, a nonaqueous solvent and an electrolyte salt are mixed to prepare an electrolytic solution. Then, the prepared electrolytic solution, a polymer compound and a diluting solvent are mixed to prepare a precursor solution in a sol form. Subsequently, the precursor solution in a sol form is coated on the surface of each of the positive electrode active material layer 13B and the negative electrode active material layer 14B, and thereafter, the diluting solvent in the precursor solution is volatilized. There is thus formed an electrolyte layer in a gel form.

Subsequently, as to each of the positive electrode 13 and the negative electrode 14 each having a gel electrolyte layer formed thereon, the positive electrode lead 11 is installed in an end of the positive electrode collector 13A by means of welding, and the negative electrode lead 12 is also installed in an end of the negative electrode collector 14A by means of welding.

Subsequently, the positive electrode 13 and the negative electrode 14 each having a gel electrolyte layer formed thereon are laminated via the separator 15 to form a laminate, and this laminate is wound in a longitudinal direction thereof, thereby forming the wound electrode body 10. Finally, for example, the wound electrode body 10 is interposed between the package members 1, and the outer edges of the package members 1 are brought into close contact with each other by means of heat fusion or the like and sealed. On that occasion, the contact film 2 is inserted between each of the positive electrode lead 11 and the negative electrode lead 12 and the package member 1. Furthermore, the fabricated battery is charged or preliminarily charged. There is thus completed the nonaqueous electrolyte battery 20 according to the seventh embodiment, in which a reduced material of at least one of the polyacid and the polyacid compound is deposited on the surface of the negative electrode 14. Similar to the first embodiment, it may be considered that the deposit deposited on the negative electrode is one derived from at least one of the heteropolyacid and a heteropolyacid compound.

Also, the gel electrolyte layer may be fabricated in the following manner. First of all, as described above, the positive electrode 13 and the negative electrode 14 are fabricated; and the positive electrode lead 11 and the negative electrode lead 12 are installed in the positive electrode 13 and the negative electrode 14, respectively. The positive electrode 13 and the negative electrode 14 are then laminated via the separator 15 and wound, thereby forming the wound electrode body 10. Subsequently, this wound electrode body 10 is interposed into the package member 1, and the outer edges exclusive of one side are subjected to heat fusion to form a bag, which is then housed in the inside of the package member 1. Subsequently, an electrolyte composition containing an electrolytic solution, a monomer as a raw material of a polymer compound, a polymerization initiator and optionally, other materials such as a polymerization inhibitor is prepared and injected into the inside of the package member 1.

After the electrolyte composition is injected, an opening of the package member 1 is hermetically sealed by means of heat fusion in a vacuum atmosphere. Subsequently, the monomer is polymerized upon heating to prepare a polymer compound, thereby forming a gel electrolyte.

[Effect]

According to the seventh embodiment, the same effects as those in the first embodiment are obtainable. That is, according to the seventh embodiment, it is possible to suppress the contact between the positive electrode 13 and the negative electrode 14 and to prevent the matter that a large current momentarily flows to cause an abrupt increase of the battery temperature from occurring. Furthermore, blister of the battery following the gas generation to be caused due to the decomposition of the electrolytic solution can be suppressed.

### 8. Eighth Embodiment

In an eighth embodiment, an example in which at least one of a heteropolyacid and a heteropolyacid compound is mixed in the positive electrode active material layer 13B but not the electrolyte in the nonaqueous electrolyte battery 20 according to the first embodiment is described. In the eighth embodiment, only points which are different from those in the first embodiment are described.

(8-1) Configuration of Nonaqueous Electrolyte Battery

[Positive Electrode]

The positive electrode 13 has, for example, the positive electrode collector 13A and the positive electrode active material layer 13B provided on the both surfaces of this positive electrode collector 13A. For the positive electrode collector 13A, for example, a metal foil such as an aluminum foil can be used. The positive electrode active material layer 13B is constituted so as to contain a positive electrode active material, a conductive assistant such as carbon materials, a binder such as polyvinylidene fluoride and polytetrafluoroethylene and at least one of the foregoing heteropolyacid and heteropolyacid compound.

[Negative Electrode]

The negative electrode active material layer 14B is, for example, constituted so as to contain, as a negative electrode active material, one or two or more kinds of a negative electrode material capable of intercalating and deintercalating lithium, and the negative electrode active material layer 14B may further contain a conductive assistant and a binder, if desired. A part of at least one of the heteropolyacid and the heteropolyacid compound added to the positive electrode is deposited as the polyacid and/or the polyacid compound, each of which contains both a polyatom ion with a valence of 6 and a polyatom ion with a valence of less than 6, on the surface of the negative electrode 14 by the electrolysis. Also, the polyacid and/or the polyacid compound may be contained among the negative electrode active material particles.

An optimal range of the deposition amount of the polyacid and/or the polyacid compound is preferably 0.01% by weight or more and not more than 5.0% by weight based on 100% by weight of the negative electrode active material. The deposition amount of the polyacid and/or the polyacid compound can be detected by means of NMR. The weight of the polyacid is defined to be a value obtained by subtracting the weight of bound water which the polyacid has. Also, similarly, the weight of the polyacid compound is defined to be a value obtained by subtracting the weight of bound water which the polyacid compound has.

Similar to the first embodiment, the polyacid or polyacid compound deposited on the surface of the negative electrode 14 can be confirmed by detecting a composition of the deposit deposited on the negative electrode collector 14A. Also, similar to the first embodiment, the reduced state of each of the deposited polyacid and polyacid compound can be confirmed by the X-ray photoelectron spectroscopy (XPS) analysis.

[Electrolyte]

The electrolyte is an electrolytic solution containing an electrolyte salt and a solvent for dissolving this electrolyte salt therein. In the eighth embodiment, at least one of a heteropolyacid and a heteropolyacid compound is not added to the electrolyte.

(8-2) Manufacturing Method of Nonaqueous Electrolyte Battery

A method for manufacturing the nonaqueous electrolyte battery according to the eighth embodiment is hereunder described. In the manufacturing method of the eighth embodiment, the case of using a gel electrolyte is described.

[Manufacturing Method of Positive Electrode]

The positive electrode 13 is manufactured in the following manner. First of all, a positive electrode active material, a binder, a conductive assistant such as carbon materials and at least one of a heteropolyacid and a heteropolyacid compound are mixed to prepare a positive electrode mixture, and this positive electrode mixture is dispersed in a solvent such as N-methyl-2-pyrrolidone to prepare a positive electrode mixture slurry. As the binder, polyvinylidene fluoride, polytetrafluoroethylene or the like is useful.

More specifically, for example, first of all, a positive electrode active material, a binder and a conductive assistant are mixed. Also, at least one of a heteropolyacid and a heteropolyacid compound is dissolved in a solvent such as N-methyl-2-pyrrolidone to prepare a solution. Subsequently, this solution and the foregoing mixture are mixed to prepare a positive electrode mixture.

Subsequently, a solvent such as N-methyl-2-pyrrolidone is further added to this positive electrode mixture, thereby dispersing the positive electrode active material, the binder, the conductive assistant and at least one of the heteropolyacid and the heteropolyacid compound in the solvent. There is thus obtained a positive electrode mixture slurry.

Subsequently, this positive electrode mixture slurry is coated on the positive electrode collector 13A and dried, and the resultant is then compression molded by a roll press or the like to form the positive electrode active material layer 13B. There is thus obtained the positive electrode 13. The conductive assistant such as carbon materials is mixed on the occasion of preparing the positive electrode mixture, as the need arises.

[Manufacturing Method of Negative Electrode]

The negative electrode 14 is fabricated in the following manner. First of all, a negative electrode active material, a binder and optionally, a conductive assistant are mixed.

Subsequently, this solution and the foregoing mixture are mixed to prepare a negative electrode mixture, and this negative electrode mixture is dispersed in a solvent such as N-methyl-2-pyrrolidone, thereby preparing a negative electrode mixture slurry. Subsequently, this negative electrode mixture slurry is coated on the negative electrode collector 14A, and after drying the solvent, the resultant is compression molded by a roll press or the like to form the negative electrode active material layer 14B. There is thus obtained the negative electrode 14.

[Manufacturing Methods of Electrolyte and Nonaqueous Electrolyte Battery]

The electrolyte is prepared in the following manner. First of all, a nonaqueous solvent and an electrolyte salt are mixed to prepare an electrolytic solution. Then, the prepared electrolytic solution, a polymer compound and a diluting solvent are mixed to prepare a precursor solution in a sol form. Subsequently, the precursor solution in a sol form is coated on the surface of each of the positive electrode active material layer 13B and the negative electrode active material layer 14B, and thereafter, the diluting solvent in the precursor solution is volatilized. There is thus formed an electrolyte layer in a gel form.

Subsequently, as to each of the positive electrode 13 and the negative electrode 14 each having a gel electrolyte layer formed thereon, the positive electrode lead 11 is installed in an end of the positive electrode collector 13A by means of welding, and the negative electrode lead 12 is also installed in an end of the negative electrode collector 14A by means of welding.

Subsequently, the positive electrode 13 and the negative electrode 14 each having a gel electrolyte layer formed thereon are laminated via the separator 15 to form a laminate, and this laminate is wound in a longitudinal direction thereof, thereby forming the wound electrode body 10. Finally, for example, the wound electrode body 10 is interposed between the package members 1, and the outer edges of the package members 1 are brought into close contact with each other by means of heat fusion or the like and sealed. On that occasion, the contact film 2 is inserted between each of the positive electrode lead 11 and the negative electrode lead 12 and the package member 1. Furthermore, the fabricated battery is charged or preliminarily charged. There is thus completed the nonaqueous electrolyte battery 20 according to the eighth embodiment, in which a reduced material of at least one of the polyacid and the polyacid compound is deposited on the surface of the negative electrode 14. Similar to the first embodiment, it may be considered that the deposit deposited on the negative electrode is one derived from at least one of the heteropolyacid and the heteropolyacid compound.

Also, the gel electrolyte layer may be fabricated in the following manner. First of all, as described above, the positive electrode 13 and the negative electrode 14 are fabricated; and the positive electrode lead 11 and the negative electrode lead 12 are installed in the positive electrode 13 and the negative electrode 14, respectively. The positive electrode 13 and the negative electrode 14 are then laminated via the separator 15 and wound, thereby forming the wound electrode body 10. Subsequently, this wound electrode body 10 is interposed into the package member 1, and the outer edges exclusive of one side are subjected to heat fusion to form a bag, which is then housed in the inside of the package member 1. Subsequently, an electrolyte composition containing an electrolytic solution, a monomer as a raw material of a polymer compound, a polymerization initiator and optionally, other materials such as a polymerization inhibitor is prepared and injected into the inside of the package member 1.

After the electrolyte composition is injected, an opening of the package member 1 is hermetically sealed by means of heat fusion in a vacuum atmosphere. Subsequently, the monomer is polymerized upon heating to prepare a polymer compound, thereby forming a gel electrolyte.

[Effect]

According to the eighth embodiment, the same effects as those in the first embodiment are obtainable. That is, according to the eighth embodiment, it is possible to suppress the contact between the positive electrode 13 and the negative electrode 14 and to prevent the matter that a large current momentarily flows to cause an abrupt increase of the battery temperature from occurring. Furthermore, blister of the battery following the gas generation to be caused due to the decomposition of the electrolytic solution can be suppressed.

### 9. Ninth Embodiment

A nonaqueous electrolyte battery according to the ninth embodiment is a nonaqueous electrolyte battery of a laminated film type, in which an electrode body is formed by laminating a positive electrode and a negative electrode and packaged by a laminated film, and is the same as that according to the third embodiment, except for the configuration of the electrode body. For that reason, only the electrode body of the ninth embodiment is hereunder described.

[Positive Electrode and Negative Electrode]

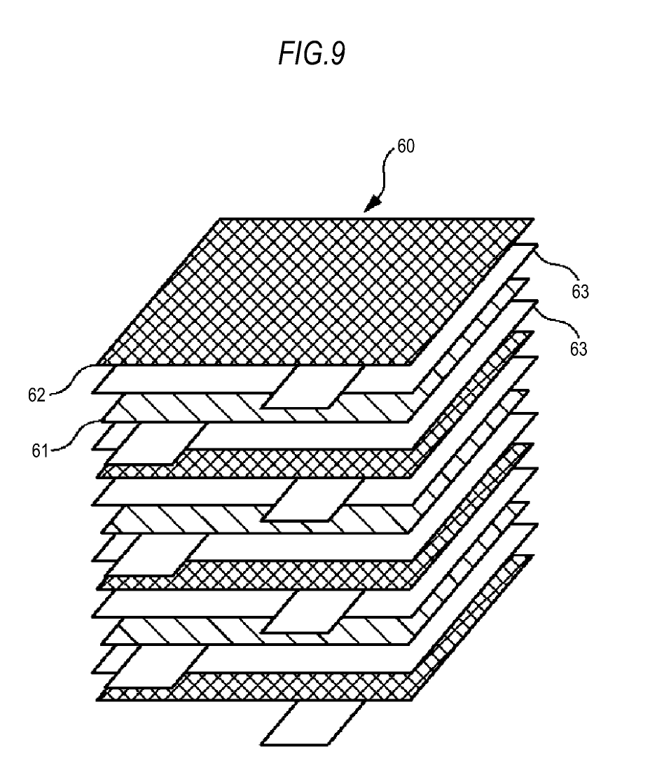

As shown in FIG. 9, a positive electrode 61 is obtained by forming a positive electrode active material layer on the both surfaces of a rectangular positive electrode collector. It is preferable that a positive electrode collector of the positive electrode 61 is formed integrally with a positive electrode terminal. Also, similarly, a negative electrode 62 is made by forming a negative electrode active layer on a rectangular negative electrode collector.

The positive electrode 61 and the negative electrode 62 are laminated in the order of the positive electrode 61, a separator 63, the negative electrode 62 and a separator 63, thereby forming a laminated electrode body 60. In the laminated electrode body 60, the laminated state of electrodes may be kept by sticking an insulating tape or the like. The laminated electrode body 60 is packaged by a laminated film or the like and hermetically sealed in the battery together with a nonaqueous electrolytic solution. Also, a gel electrolyte may be used in place of the nonaqueous electrolytic solution.

### 10. Other Embodiments

### Modification Examples

The shape of the nonaqueous electrolyte battery is not limited to those described above. For example, the shape of the nonaqueous electrolyte battery may be a coin type or the like.

Also, for example, a polymer solid electrolyte constituted of an ion conductive polymer material, an inorganic solid electrolyte constituted of an inorganic material with ion conductivity and the like may be used as the electrolyte. Examples of the ion conductive polymer material include polyethers, polyesters, polyphosphazenes and polysiloxanes. Also, examples of the inorganic solid electrolyte include ion conductive ceramics, ion conductive crystals and ion conductive glasses.

### EXAMPLES

The present embodiments are specifically described below with reference to the following Examples, but it should not be construed that the embodiments are limited only to these Examples. The weight of the heteropolyacid is defined to be a value obtained by subtracting the weight of bound water which the heteropolyacid has. Also, similarly, the weight of the heteropolyacid compound is defined to be a value obtained by subtracting the weight of bound water which the heteropolyacid compound has.

### Example 1

### Case of Adding Silicotungstic Acid to a Positive Electrode, Thereby Depositing at Least One of a Polyacid and a Polyacid Compound on a Negative Electrode Surface

<Sample 1-1>

First of all, 90 parts by mass of a positive electrode active material made of a complex oxide particle having an average composition of Li_{0.98}Co_{0.15}Ni_{0.80}Al_{0.05}O₂, 5 parts by mass of graphite as a conductive agent and 5 parts by mass of polyvinylidene fluoride as a binder were mixed.

Subsequently, silicotungstic acid (H₄(SiW₁₂O₄₀)) was dissolved in N-methyl-2-pyrrolidone to prepare a 10% by weight silicotungstic acid solution. Then, the silicotungstic acid solution in which the addition amount of silicotungstic acid was corresponding to 0.005% by weight of the foregoing positive electrode active material was added to the foregoing mixture. Furthermore, the mixture was added with a prescribed amount of N-methyl-2-pyrrolidone as a dispersion medium and dispersed, thereby preparing a positive electrode mixture slurry.

This positive electrode mixture slurry was uniformly coated on the both surfaces of a positive electrode collector made of an aluminum foil having a thickness of 20 μm and then dried, and the resultant was compression molded by a roll press to form a positive electrode active material layer, thereby fabricating a positive electrode. Subsequently, a positive electrode lead was installed in a positive electrode collector exposed portion of the positive electrode.

Subsequently, 95 parts by mass of a pulverized graphite powder as a negative electrode active material and 5 parts by mass of polyvinylidene fluoride as a binder were mixed to prepare a negative electrode mixture, which was then dispersed in N-methyl-2-pyrrolidone as a dispersion medium to form a negative electrode mixture slurry. Subsequently, this negative electrode mixture slurry was uniformly coated on the both surfaces of a negative electrode collector made of a copper foil having a thickness of 15 μm and then dried, and the resultant was compression molded by a roll press to form a negative electrode active material layer, thereby fabricating a negative electrode. Subsequently, a negative electrode lead was installed in a negative electrode collector exposed portion of the negative electrode.

Subsequently, the fabricated positive electrode and negative electrode were brought into close contact with each other via a separator made of a microporous polyethylene film having a thickness of 25 μm and wound in a longitudinal direction, and a protective tape was stuck to an outermost peripheral part, thereby fabricating a wound electrode body. Subsequently, this wound electrode body was filled in a package member, and three sides of the package member were heat fused, while the remaining one side was opened without being heat fused. For the package member, a moistureproof aluminum laminated film obtained by laminating a 25 μm-thick nylon film, a 40 μm-thick aluminum foil and a 30 μm-thick polypropylene film in this order from the outermost layer was used.

Subsequently, 1 mole/L of lithium hexafluorophosphate (LiPF₆) as an electrolyte salt was dissolved in a mixed solvent of ethylene carbonate (EC) and ethyl methyl carbonate (EMC) in a mass ratio of 5/5, thereby preparing an electrolytic solution. This electrolytic solution was injected from the opening of the package material, and the remaining one side of the package member was heat fused under a reduced pressure to hermetically seal the package member. There was thus fabricated a secondary battery.

Subsequently, the fabricated battery was preliminarily charged to 3.2 V at 100 mA, thereby achieving electrolytic reduction of silicotungstic acid. At that time, by disassembling the battery, it could be confirmed that a coating film in a gel form was formed on the negative electrode surface. A change in the capacity of the positive electrode at this stage is extremely small such that it is negligible. According to this, a test secondary battery having a tungsten compound deposited on the negative electrode was fabricated.

<Sample 1-2>

A secondary battery was fabricated in the same manner as in Sample 1-1, except that the addition amount of silicotungstic acid was regulated to 0.20% by weight of the positive electrode active material.

<Sample 1-3>

A secondary battery was fabricated in the same manner as in Sample 1-1, except that the addition amount of silicotungstic acid was regulated to 0.50% by weight of the positive electrode active material.

<Sample 1-4>

A secondary battery was fabricated in the same manner as in Sample 1-1, except that the addition amount of silicotungstic acid was regulated to 1.0% by weight of the positive electrode active material.

<Sample 1-5>

A secondary battery was fabricated in the same manner as in Sample 1-1, except that the addition amount of silicotungstic acid was regulated to 3.0% by weight of the positive electrode active material.

<Sample 1-6>

A secondary battery was fabricated in the same manner as in Sample 1-1, except that the addition amount of silicotungstic acid was regulated to 5.0% by weight of the positive electrode active material.

<Sample 1-7>

A secondary battery was fabricated in the same manner as in Sample 1-1, except that the addition amount of silicotungstic acid was regulated to 7.0% by weight of the positive electrode active material.

<Sample 1-8>

A secondary battery was fabricated in the same manner as in Sample 1-1, except that the addition of silicotungstic acid was not performed.

<Sample 1-9>

A secondary battery was fabricated in the same manner as in Sample 1-1, except that a positive electrode active material having an average composition of Li_{1.02}Co_{0.98}Mg_{0.01}Al_{0.01}O₂ was used; and that the addition amount of silicotungstic acid was regulated to 0.005% by weight. The secondary battery was preliminarily charged in the same manner as in Sample 1-1 and then disassembled. As a result, a deposit or the like was not confirmed on the negative electrode surface.

<Sample 1-10>

A secondary battery was fabricated in the same manner as in Sample 1-9, except that the addition amount of silicotungstic acid was regulated to 0.20% by weight of the positive electrode active material.

<Sample 1-11>

A secondary battery was fabricated in the same manner as in Sample 1-9, except that the addition amount of silicotungstic acid was regulated to 0.50% by weight of the positive electrode active material.

<Sample 1-12>

A secondary battery was fabricated in the same manner as in Sample 1-9, except that the addition amount of silicotungstic acid was regulated to 1.0% by weight of the positive electrode active material.

<Sample 1-13>

A secondary battery was fabricated in the same manner as in Sample 1-9, except that the addition of silicotungstic acid was not performed.

[Evaluation of Secondary Battery: Blister Amount of Battery]

The secondary battery of each of the samples was subjected to constant-current charge at a constant current of 880 mA in an environment at 23° C. until a battery voltage reached 4.2 V and then to constant-voltage charge at a constant voltage of 4.2 V until a current value reached 1 mA. Thereafter, the secondary battery in a fully charged state was stored in an environment at 80° C. for 4 days. At that time, an amount of change in a thickness of the secondary battery was measured as a blister amount of the battery at the time of high-temperature storage.

[Evaluation of Secondary Battery: Discharge Capacity]

With respect to each of the secondary batteries of Samples 1-1 to 1-8 using Li_{0.98}Co_{0.15}Ni_{0.80}Al_{0.05}O₂ as the positive electrode active material, a discharge capacity thereof was measured. First of all, each secondary battery was subjected to constant-current charge at a constant current of 880 mA in an environment at 23° C. until a battery voltage reached 4.2 V and then to constant-voltage charge at a constant voltage of 4.2 V until a current value reached 1 mA. Subsequently, the secondary battery was discharged with 0.2 C, and a discharge capacity until the battery voltage reached 3.0 V was measured.

[Evaluation of Secondary Battery: Valence of Tungsten Ion]

The secondary battery of each of the samples was subjected to constant-current charge at a constant current of 880 mA in an environment at 23° C. until a battery voltage reached 4.2 V and then to constant-voltage charge at a constant voltage of 4.2 V until a current value reached 1 mA. Subsequently, the secondary battery was discharged with 0.2 C until the battery voltage reached 3.0 V, the battery was then disassembled in an inert atmosphere, and the taken out positive electrode and negative electrode were washed with dimethyl carbonate for 30 seconds. Thereafter, the surface of each of the positive electrode and the negative electrode was subjected to the XPS (X-ray photoelectron spectroscopy) analysis, thereby examining whether or not a tungsten ion with a valence of 6 and a tungsten ion with a valence of less than 6 were existent.

Specifically, by subjecting the measured spectrum to wave analysis using a commercially available software program, peaks assigned to an inner shell electron of each of 4f7/2 and 4f5/2 of tungsten and of 2s of fluorine as a coexisting element were separated, thereby confirming an energy position at which a peak assigned to an inner shell electron of 4f7/2 is existent. On that occasion, a peak area ratio of 4f7/2 to 4f5/2 was defined to be 4/3 which is a theoretical value from the spin-orbit interaction splitting. Then, when a peak of 4f7/2 is existent in the binding energy range of 32.0 eV or more and not more than 35.4 eV, it is defined that a tungsten ion with a valence of less than 6 is to be existent; whereas when a peak of 4f7/2 is existent in the binding energy range of 35.4 eV or more and not more than 36.9 eV, it is defined that a tungsten ion with a valence of 6 is existent.

On that occasion, QUANTERA SXM, manufactured by Ulvac-Phi, Inc. was used as an X-ray photoelectron spectroscope. Also, as an analysis condition, monochromated Al—Kαrays (1,486.6 eV, beam size: about 100 μmΦ) were irradiated, thereby measuring a photoelectron spectrum. A charge neutralization treatment was not performed. For the energy correction of the spectrum, a fluorine is peak was used. Specifically, an F 1s spectrum of the sample was measured, a wave analysis was performed, and a position of a main peak existent on the lowest binding energy side was defined to be 685.1 eV. For the wave analysis, a commercially available software program was used.

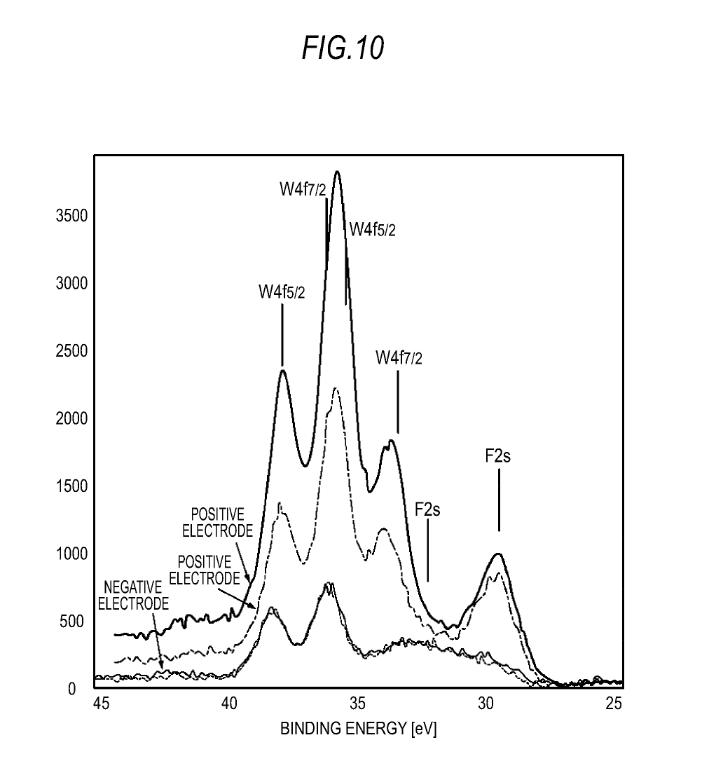

For reference, the XPS analysis results of a negative electrode surface of Sample 1-3 using XPS are shown in FIG. 10.

The evaluation results are shown in the following Table 1.

TABLE 1

| | | | Addition | Presence of tungsten ion | |
|---|---|---|---|---|---|
| | | | amount | Positive electrode surface | |
| | Positive electrode active | | [% by | Valence of | Valence |
| | material | Heteropolyacid | weight] | less than 6 | of 6 |
| Sample 1-1 | Li_{0.98}Co_{0.15}Ni_{0.80}Al_{0.05}O₂ | Silicotungstic acid | 0.005 | No | Yes |
| Sample 1-2 | | Silicotungstic acid | 0.20 | No | Yes |
| Sample 1-3 | | Silicotungstic acid | 0.50 | No | Yes |
| Sample 1-4 | | Silicotungstic acid | 1.0 | No | Yes |
| Sample 1-5 | | Silicotungstic acid | 3.0 | No | Yes |
| Sample 1-6 | | Silicotungstic acid | 5.0 | No | Yes |
| Sample 1-7 | | Silicotungstic acid | 7.0 | No | Yes |
| Sample 1-8 | | — | — | No | No |
| Sample 1-9 | Li_{1.02}Co_{0.98}Mg_{0.01}Al_{0.01}O₂ | Silicotungstic acid | 0.005 | No | Yes |
| Sample 1-10 | | Silicotungstic acid | 0.20 | No | Yes |
| Sample 1-11 | | Silicotungstic acid | 0.50 | No | Yes |
| Sample 1-12 | | Silicotungstic acid | 1.0 | No | Yes |
| Sample 1-13 | | — | — | No | No |

| | Presence of tungsten ion | | | |
|---|---|---|---|---|
| | Negative electrode surface | | Blister | Discharge |
| | Valence of | Valence | amount | capacity |
| | less than 6 | of 6 | [mm] | [mAh/g] |
| Sample 1-1 | Yes | No | 10.1 | 185.1 |
| Sample 1-2 | Yes | Yes | 3.81 | 183.7 |
| Sample 1-3 | Yes | Yes | 3.13 | 183.0 |
| Sample 1-4 | Yes | Yes | 2.90 | 182.1 |
| Sample 1-5 | Yes | Yes | 2.51 | 175.6 |
| Sample 1-6 | Yes | Yes | 2.25 | 168.2 |
| Sample 1-7 | Yes | Yes | 2.45 | 154.9 |
| Sample 1-8 | No | No | 16.3 | 185.5 |
| Sample 1-9 | Yes | No | 6.29 | — |
| Sample 1-10 | Yes | Yes | 3.45 | — |
| Sample 1-11 | Yes | Yes | 2.81 | — |
| Sample 1-12 | Yes | Yes | 2.40 | — |
| Sample 1-13 | No | No | 8.01 | — |

Samples 1-1 to 1-7 and Samples 1-9 to 1-12 are concerned with a secondary battery fabricated by adding silicotungstic acid to the positive electrode. From the results of the XPS analysis shown in Table 1, in these secondary batteries, the tungsten compound was confirmed to exist on the surface of each of the positive electrode and the negative electrode. Also, with respect to the valence of the tungsten ion, only a tungsten ion with a valence of 6 was existent in the positive electrode, whereas both a tungsten ion with a valence of less than 6 and a tungsten ion with a valence of 6 were contained in the negative electrode. In consequence, it was confirmed that in view of the fact that a part of silicotungstic acid added to the positive electrode elutes, an averagely reduced tungsten compound deposits and exists on the surface of the negative electrode as compared with the positive electrode.

As shown in Table 1, it was noted that in the secondary batteries constituted so as to add silicotungstic acid to the positive electrode, thereby depositing the tungsten compound on the negative electrode surface, the battery blister can be suppressed as compared with the secondary batteries of Samples 1-8 and 1-13 not containing silicotungstic acid. In particular, it was noted that in the secondary batteries constituted in such a manner that the tungsten compound having both a tungsten ion with a valence of 6 and a tungsten ion with a valence of less than 6 is deposited on the negative electrode surface, the battery blister can be remarkably suppressed as compared with the secondary batteries of Samples 1-1 and 1-9 in which only a tungsten ion with a valence of less than 6 is existent.

Samples 1-1 to 1-8 are one using Li_{0.98}Co_{0.15}Ni_{0.80}Al_{0.05}O₂ as the positive electrode active material. As shown in Table 1, it was noted that by depositing the tungsten compound so as to have both a tungsten ion with a valence of 6 and a tungsten ion with a valence of less than 6, the blister amount of the battery is small as compared with Sample 1-8 in which silicotungstic acid is not added and Sample 1-1 in which a hexavalent tungsten ion is not existent. Then, it was noted that the effect for suppressing the battery blister increases with an increase of the addition amount of silicotungstic acid; and that when the addition amount of silicotungstic acid is 1.0% by weight or more, the substantially equal effect is kept. Furthermore, the discharge capacity was lowered with an increase of the addition amount of silicotungstic acid, and for example, when the addition amount of silicotungstic acid was 7.0% by weight, the discharge capacity was abruptly lowered.

Samples 1-9 to 1-13 are one using Li_{1.02}Co_{0.98}Mg_{0.01}Al_{0.01}O₂ as the positive electrode active material. Similar to Samples 1-1 to 1-8, when the tungsten compound was deposited so as to have both a tungsten ion with a valence of 6 and a tungsten ion with a valence of less than 6, the battery blister could be suppressed.

As noted from the comparison with Samples 1-8 and 1-13, when the positive electrode active material having a high content of nickel (Ni) is used, the gas generation amount is high, and the battery blister becomes large. However, in Samples 1-4 and 1-12 in which the same amount of silicotungstic acid is added, the amount of the battery blister is substantially equal, and in particular, it was noted that the addition of silicotungstic acid is remarkably effective for suppressing the battery blister against the secondary battery using a positive electrode active material having a high nickel (Ni) content.

### Example 2

### Case of Adding Phosphomolybdic Acid to a Positive Electrode, Thereby Depositing at Least One of a Polyacid and a Polyacid Compound on a Negative Electrode Surface

<Sample 2-1>

A secondary battery was fabricated in the same manner as in Sample 1-1, except that phosphomolybdic acid (H₃(PMo₁₂O₄₀) was added as an additive in an amount of 0.005% by weight of the positive electrode active material.

<Sample 2-2>

A secondary battery was fabricated in the same manner as in Sample 2-1, except that the addition amount of phosphomolybdic acid was regulated to 0.20% by weight of the positive electrode active material.

<Sample 2-3>

A secondary battery was fabricated in the same manner as in Sample 2-1, except that the addition amount of phosphomolybdic acid was regulated to 0.50% by weight of the positive electrode active material.

<Sample 2-4>

A secondary battery was fabricated in the same manner as in Sample 2-1, except that the addition amount of phosphomolybdic acid was regulated to 1.0% by weight of the positive electrode active material.

<Sample 2-5>

A secondary battery was fabricated in the same manner as in Sample 2-1, except that the addition amount of phosphomolybdic acid was regulated to 3.0% by weight of the positive electrode active material.

<Sample 2-6>

A secondary battery was fabricated in the same manner as in Sample 2-1, except that the addition amount of phosphomolybdic acid was regulated to 5.0% by weight of the positive electrode active material.

<Sample 2-7>

A secondary battery was fabricated in the same manner as in Sample 2-1, except that the addition amount of phosphomolybdic acid was regulated to 7.0% by weight of the positive electrode active material.

<Sample 2-8>

A secondary battery was fabricated in the same manner as in Sample 2-1, except that the addition of phosphomolybdic acid was not performed.

<Sample 2-9>

A secondary battery was fabricated in the same manner as in Sample 2-1, except that a positive electrode active material having an average composition of Li_{1.02}Co_{0.98}Mg_{0.01}Al_{0.01}O₂ was used; and that the addition amount of phosphomolybdic acid was regulated to 0.005% by weight.

<Sample 2-10>

A secondary battery was fabricated in the same manner as in Sample 2-9, except that the addition amount of phosphomolybdic acid was regulated to 0.20% by weight of the positive electrode active material.

<Sample 2-11>

A secondary battery was fabricated in the same manner as in Sample 2-9, except that the addition amount of phosphomolybdic acid was regulated to 0.50% by weight of the positive electrode active material.

<Sample 2-12>

A secondary battery was fabricated in the same manner as in Sample 2-9, except that the addition amount of phosphomolybdic acid was regulated to 1.0% by weight of the positive electrode active material.

<Sample 2-13>

A secondary battery was fabricated in the same manner as in Sample 2-9, except that the addition of phosphomolybdic acid was not performed.

[Evaluation of Test Battery]

Each of the test batteries was subjected to an evaluation test of blister amount of battery and a test of discharge capacity in the same manners as in Example 1.

[Evaluation of Secondary Battery: Valence of Molybdenum Ion]

The secondary battery of each of the samples was subjected to constant-current charge at a constant current of 880 mA in an environment at 23° C. until a battery voltage reached 4.2 V and then to constant-voltage charge at a constant voltage of 4.2 V until a current value reached 1 mA. Subsequently, the secondary battery was discharged with 0.2 C until the battery voltage reached 3.0 V, the battery was then disassembled in an inert atmosphere, and the taken out positive electrode and negative electrode were washed with dimethyl carbonate for 30 seconds. Thereafter, the surface of each of the positive electrode and the negative electrode was subjected to the XPS (X-ray photoelectron spectroscopy) analysis, thereby examining whether or not a molybdenum ion with a valence of 6 and a molybdenum ion with a valence of less than 6 were existent.

Specifically, by subjecting the measured spectrum to wave analysis using a commercially available software program, peaks assigned to an inner shell electron of each of 3d5/2 and 3d3/2 of molybdenum with each valence were separated, thereby confirming an energy position at which a peak assigned to an inner shell electron of 3d5/2 is existent. On that occasion, a peak area ratio of 3d5/2 and 3d3/2 was defined to be 3/2 which is a theoretical value from the spin-orbit interaction splitting. Then, when a peak of 3d5/2 is existent in the binding energy range of 227.0 eV or more and not more than 231.5 eV, it is defined that a molybdenum ion with a valence of less than 6 is to be existent; whereas when a peak of 3d5/2 is existent in the binding energy range of 231.5 eV or more and not more than 233.0 eV, it is defined that a molybdenum ion with a valence of 6 is existent.

On that occasion, the XPS analysis apparatus, the analysis condition and the analysis method were made identical to those in Example 1.

The evaluation results are shown in the following Table 2.

TABLE 2

| | | | Addition | Presence of molybdenum ion | |
|---|---|---|---|---|---|
| | | | amount | Positive electrode surface | |
| | Positive electrode | | [% by | Valence of | Valence |
| | active material | Heteropolyacid | weight] | less than 6 | of 6 |
| Sample 2-1 | Li_{0.98}Co_{0.15}Ni_{0.80}Al_{0.05}O₂ | Phosphomolybdic acid | 0.005 | No | Yes |
| Sample 2-2 | | Phosphomolybdic acid | 0.20 | No | Yes |
| Sample 2-3 | | Phosphomolybdic acid | 0.50 | No | Yes |
| Sample 2-4 | | Phosphomolybdic acid | 1.0 | No | Yes |
| Sample 2-5 | | Phosphomolybdic acid | 3.0 | No | Yes |
| Sample 2-6 | | Phosphomolybdic acid | 5.0 | No | Yes |
| Sample 2-7 | | Phosphomolybdic acid | 7.0 | No | Yes |
| Sample 2-8 | | — | — | No | No |
| Sample 2-9 | Li_{1.02}Co_{0.98}Mg_{0.01}Al_{0.01}O₂ | Phosphomolybdic acid | 0.005 | No | Yes |
| Sample 2-10 | | Phosphomolybdic acid | 0.20 | No | Yes |
| Sample 2-11 | | Phosphomolybdic acid | 0.50 | No | Yes |
| Sample 2-12 | | Phosphomolybdic acid | 1.0 | No | Yes |
| Sample 2-13 | | — | — | No | No |

| | Presence of molybdenum ion | | | |
|---|---|---|---|---|
| | Negative electrode surface | | Blister | Discharge |
| | Valence of | Valence | amount | capacity |
| | less than 6 | of 6 | [mm] | [mAh/g] |
| Sample 2-1 | Yes | No | 10.4 | 185.1 |
| Sample 2-2 | Yes | Yes | 3.90 | 184.0 |
| Sample 2-3 | Yes | Yes | 3.22 | 183.0 |
| Sample 2-4 | Yes | Yes | 2.85 | 182.1 |
| Sample 2-5 | Yes | Yes | 2.64 | 177.0 |
| Sample 2-6 | Yes | Yes | 2.32 | 169.2 |
| Sample 2-7 | Yes | Yes | 2.33 | 154.5 |
| Sample 2-8 | No | No | 16.2 | 185.4 |
| Sample 2-9 | Yes | No | 6.40 | — |
| Sample 2-10 | Yes | Yes | 3.57 | — |
| Sample 2-11 | Yes | Yes | 3.01 | — |
| Sample 2-12 | Yes | Yes | 2.54 | — |
| Sample 2-13 | No | No | 8.04 | — |

Samples 2-1 to 2-7 and Samples 2-9 to 2-12 are concerned with a secondary battery fabricated by adding phosphomolybdic acid to the positive electrode. From the results of the XPS analysis shown in Table 2, in these secondary batteries, the molybdenum compound was confirmed to exist on the surface of each of the positive electrode and the negative electrode. Also, with respect to the valence of the molybdenum ion, only a molybdenum ion with a valence of 6 was existent in the positive electrode, whereas a molybdenum ion with a valence of less than 6 was also contained in the negative electrode. In consequence, it was confirmed that in view of the fact that a part of phosphomolybdic acid added to the positive electrode elutes, an averagely reduced tungsten compound deposits and exists on the surface of the negative electrode as compared with the positive electrode.

As shown in Table 2, it was noted that in the secondary batteries constituted so as to add phosphomolybdic acid to the positive electrode, thereby depositing the molybdenum compound on the negative electrode surface, the battery blister can be suppressed as compared with the secondary batteries of Samples 2-8 and 2-13 not containing phosphomolybdic acid. In particular, it was noted that in the secondary batteries in which the molybdenum compound having both a molybdenum ion with a valence of 6 and a molybdenum ion with a valence of less than 6 is deposited, the battery blister can be remarkably suppressed as compared with the secondary batteries of Samples 2-1 and 2-9 in which only a molybdenum ion with a valence of less than 6 is existent.

Samples 2-1 to 2-8 are one using Li_{0.98}Co_{0.15}Ni_{0.80}Al_{0.05}O₂ as the positive electrode active material. As shown in Table 2, it was noted that by depositing the molybdenum compound so as to have both a molybdenum ion with a valence of 6 and a molybdenum ion with a valence of less than 6, the blister amount of the battery is small as compared with Sample 2-8 in which phosphomolybdic acid is not added and Sample 2-1 in which a hexavalent molybdenum ion is not existent. Then, it was noted that the effect for suppressing the battery blister increases with an increase of the addition amount of phosphomolybdic acid; and that when the addition amount of phosphomolybdic acid is 1.0% by weight or more, the substantially equal effect is kept. Furthermore, the discharge capacity was lowered with an increase of the addition amount of phosphomolybdic acid, and for example, when the addition amount of phosphomolybdic acid was 7.0% by weight, the discharge capacity was abruptly lowered.

Samples 2-9 to 2-13 are one using Li_{1.02}Co_{0.98}Mg_{0.01}Al_{0.01}O₂ as the positive electrode active material. Similar to Samples 2-1 to 2-8, when the molybdenum compound was deposited so as to have both a molybdenum ion with a valence of 6 and a molybdenum ion with a valence of less than 6, the battery blister could be suppressed.

As noted from the comparison with Samples 2-8 and 2-13, when the positive electrode active material having a high content of nickel (Ni) is used, the gas generation amount is high, and the battery blister becomes large. However, in Samples 2-4 and 2-12 in which the same amount of phosphomolybdic acid is added, the amount of the battery blister is substantially equal, and in particular, it was noted that the addition of phosphomolybdic acid is remarkably effective for suppressing the battery blister against the secondary battery using a positive electrode active material having a high nickel (Ni) content.

### Example 3

### Case of Adding Phosphotungstic Acid to a Positive Electrode, Thereby Depositing at Least One of a Polyacid and a Polyacid Compound on a Negative Electrode Surface

<Sample 3-1>

A secondary battery was fabricated in the same manner as in Sample 1-1, except that phosphotungstic acid (H₃(PW₁₂O₄₀) was added as an additive in an amount of 0.005% by weight of the positive electrode active material.

<Sample 3-2>

A secondary battery was fabricated in the same manner as in Sample 3-1, except that the addition amount of phosphotungstic acid was regulated to 0.20% by weight of the positive electrode active material.

<Sample 3-3>

A secondary battery was fabricated in the same manner as in Sample 3-1, except that the addition amount of phosphotungstic acid was regulated to 0.50% by weight of the positive electrode active material.

<Sample 3-4>

A secondary battery was fabricated in the same manner as in Sample 3-1, except that the addition amount of phosphotungstic acid was regulated to 1.0% by weight of the positive electrode active material.

<Sample 3-5>

A secondary battery was fabricated in the same manner as in Sample 3-1, except that the addition amount of phosphotungstic acid was regulated to 3.0% by weight of the positive electrode active material.

<Sample 3-6>

A secondary battery was fabricated in the same manner as in Sample 3-1, except that the addition amount of phosphotungstic acid was regulated to 5.0% by weight of the positive electrode active material.

<Sample 3-7>

A secondary battery was fabricated in the same manner as in Sample 3-1, except that the addition amount of phosphotungstic acid was regulated to 7.0% by weight of the positive electrode active material.

<Sample 3-8>

A secondary battery was fabricated in the same manner as in Sample 3-1, except that the addition of phosphotungstic acid was not performed.

<Sample 3-9>

A secondary battery was fabricated in the same manner as in Sample 3-1, except that a positive electrode active material having an average composition of Li_{1.02}Co_{0.98}Mg_{0.01}Al_{0.01}O₂ was used; and that the addition amount of phosphotungstic acid was regulated to 0.005% by weight.

<Sample 3-10>

A secondary battery was fabricated in the same manner as in Sample 3-9, except that the addition amount of phosphotungstic acid was regulated to 0.20% by weight of the positive electrode active material.

<Sample 3-11>

A secondary battery was fabricated in the same manner as in Sample 3-9, except that the addition amount of phosphotungstic acid was regulated to 0.50% by weight of the positive electrode active material.

<Sample 3-12>

A secondary battery was fabricated in the same manner as in Sample 3-9, except that the addition amount of phosphotungstic acid was regulated to 1.0% by weight of the positive electrode active material.

<Sample 3-13>

A secondary battery was fabricated in the same manner as in Sample 3-9, except that the addition of phosphotungstic acid was not performed.

[Evaluation of Test Battery]

Each of the test batteries was subjected to an evaluation test of blister amount of battery, a test of discharge capacity and an XPS analysis in the same manners as in Example 1.

The evaluation results are shown in the following Table 3.

TABLE 3

| | | | Addition | Presence of tungsten ion | |
|---|---|---|---|---|---|
| | | | amount | Positive electrode surface | |
| | Positive electrode | | [% by | Valence of | Valence |
| | active material | Heteropolyacid | weight] | less than 6 | of 6 |
| Sample 3-1 | Li_{0.98}Co_{0.15}Ni_{0.80}Al_{0.05}O₂ | Phosphotungstic acid | 0.005 | No | Yes |
| Sample 3-2 | | Phosphotungstic acid | 0.20 | No | Yes |
| Sample 3-3 | | Phosphotungstic acid | 0.50 | No | Yes |
| Sample 3-4 | | Phosphotungstic acid | 1.0 | No | Yes |
| Sample 3-5 | | Phosphotungstic acid | 3.0 | No | Yes |
| Sample 3-6 | | Phosphotungstic acid | 5.0 | No | Yes |
| Sample 3-7 | | Phosphotungstic acid | 7.0 | No | Yes |
| Sample 3-8 | | — | — | No | No |
| Sample 3-9 | Li_{1.02}Co_{0.98}Mg_{0.01}Al_{0.01}O₂ | Phosphotungstic acid | 0.005 | No | Yes |
| Sample 3-10 | | Phosphotungstic acid | 0.20 | No | Yes |
| Sample 3-11 | | Phosphotungstic acid | 0.50 | No | Yes |
| Sample 3-12 | | Phosphotungstic acid | 1.0 | No | Yes |
| Sample 3-13 | | — | — | No | No |

| | Presence of tungsten ion | | | |
|---|---|---|---|---|
| | Negative electrode surface | | Blister | Discharge |
| | Valence of | Valence | amount | capacity |
| | less than 6 | of 6 | [mm] | [mAh/g] |
| Sample 3-1 | Yes | No | 10.4 | 185.1 |
| Sample 3-2 | Yes | Yes | 3.95 | 183.4 |
| Sample 3-3 | Yes | Yes | 3.18 | 181.8 |
| Sample 3-4 | Yes | Yes | 2.76 | 180.9 |
| Sample 3-5 | Yes | Yes | 2.59 | 176.1 |
| Sample 3-6 | Yes | Yes | 2.30 | 168.4 |
| Sample 3-7 | Yes | Yes | 2.15 | 155.6 |
| Sample 3-8 | No | No | 16.4 | 185.5 |
| Sample 3-9 | Yes | No | 6.33 | — |
| Sample 3-10 | Yes | Yes | 3.47 | — |
| Sample 3-11 | Yes | Yes | 2.87 | — |
| Sample 3-12 | Yes | Yes | 2.48 | — |
| Sample 3-13 | No | No | 7.99 | — |

Samples 3-1 to 3-7 and Samples 3-9 to 3-12 are concerned with a secondary battery fabricated by adding phosphotungstic acid to the positive electrode. From the results of the XPS analysis shown in Table 3, in these secondary batteries, the tungsten compound was confirmed to exist on the surface of each of the positive electrode and the negative electrode. Also, with respect to the valence of the tungsten ion, only a tungsten ion with a valence of 6 was existent in the positive electrode, whereas a tungsten ion with a valence of less than 6 was also contained in the negative electrode. In consequence, it was confirmed that in view of the fact that a part of phosphotungstic acid added to the positive electrode elutes, an averagely reduced tungsten compound deposits and exists on the surface of the negative electrode as compared with the positive electrode.

As shown in Table 3, it was noted that in the secondary batteries constituted so as to add phosphotungstic acid to the positive electrode, thereby depositing the tungsten compound on the negative electrode surface, the battery blister can be suppressed as compared with the secondary batteries of Samples 3-8 and 3-13 not containing phosphotungstic acid. In particular, it was noted that in the secondary batteries constituted in such a manner that the tungsten compound having both a tungsten ion with a valence of 6 and a tungsten ion with a valence of less than 6 is deposited on the negative electrode surface, the battery blister can be remarkably suppressed as compared with the secondary batteries of Samples 3-1 and 3-9 in which only a tungsten ion with a valence of less than 6 is existent.

Samples 3-1 to 3-8 are one using Li_{0.98}Co_{0.15}Ni_{0.80}Al_{0.05}O₂ as the positive electrode active material. As shown in Table 3, it was noted that by depositing the tungsten compound so as to have both a tungsten ion with a valence of 6 and a tungsten ion with a valence of less than 6, the blister amount of the battery is small as compared with Sample 3-8 in which phosphotungstic acid is not added and Sample 3-1 in which a hexavalent tungsten ion is not existent. Then, it was noted that the effect for suppressing the battery blister increases with an increase of the addition amount of phosphotungstic acid; and that when the addition amount of phosphotungstic acid is 1.0% by weight or more, the substantially equal effect is kept. Furthermore, the discharge capacity was lowered with an increase of the addition amount of phosphotungstic acid, and for example, when the addition amount of phosphotungstic acid was 7.0% by weight, the discharge capacity was abruptly lowered.

Samples 3-9 to 3-13 are one using Li_{1.02}Co_{0.98}Mg_{0.01}Al_{0.01}O₂ as the positive electrode active material. Similar to Samples 3-1 to 3-8, when the tungsten compound was deposited so as to have both a tungsten ion with a valence of 6 and a tungsten ion with a valence of less than 6, the battery blister could be suppressed.

As noted from the comparison with Samples 3-8 and 3-13, when the positive electrode active material having a high content of nickel (Ni) is used, the gas generation amount is high, and the battery blister becomes large. However, in Samples 3-4 and 3-12 in which the same amount of phosphotungstic acid is added, the amount of the battery blister is substantially equal, and in particular, it was noted that the addition of phosphotungstic acid is remarkably effective for suppressing the battery blister against the secondary battery using a positive electrode active material having a high nickel (Ni) content.

### Example 4

### Case of Adding Silicomolybdic Acid to a Positive Electrode, Thereby Depositing at Least One of a Polyacid and a Polyacid Compound on a Negative Electrode Surface

<Sample 4-1>

A secondary battery was fabricated in the same manner as in Sample 1-1, except that silicomolybdic acid (H₄(SiMo₁₂O₄₀) was added as an additive in an amount of 0.005% by weight of the positive electrode active material.

<Sample 4-2>

A secondary battery was fabricated in the same manner as in Sample 4-1, except that the addition amount of silicomolybdic acid was regulated to 0.20% by weight of the positive electrode active material.

<Sample 4-3>

A secondary battery was fabricated in the same manner as in Sample 4-1, except that the addition amount of silicomolybdic acid was regulated to 0.50% by weight of the positive electrode active material.

<Sample 4-4>

A secondary battery was fabricated in the same manner as in Sample 4-1, except that the addition amount of silicomolybdic acid was regulated to 1.0% by weight of the positive electrode active material.

<Sample 4-5>

A secondary battery was fabricated in the same manner as in Sample 4-1, except that the addition amount of silicomolybdic acid was regulated to 3.0% by weight of the positive electrode active material.

<Sample 4-6>

A secondary battery was fabricated in the same manner as in Sample 4-1, except that the addition amount of silicomolybdic acid was regulated to 5.0% by weight of the positive electrode active material.

<Sample 4-7>

A secondary battery was fabricated in the same manner as in Sample 4-1, except that the addition amount of silicomolybdic acid was regulated to 7.0% by weight of the positive electrode active material.

<Sample 4-8>

A secondary battery was fabricated in the same manner as in Sample 4-1, except that the addition of silicomolybdic acid was not performed.

<Sample 4-9>

A secondary battery was fabricated in the same manner as in Sample 4-1, except that a positive electrode active material having an average composition of Li_{1.02}Co_{0.98}Mg_{0.01}Al_{0.01}O₂ was used; and that the addition amount of silicomolybdic acid was regulated to 0.005% by weight.

<Sample 4-10>

A secondary battery was fabricated in the same manner as in Sample 4-9, except that the addition amount of silicomolybdic acid was regulated to 0.20% by weight of the positive electrode active material.

<Sample 4-11>

A secondary battery was fabricated in the same manner as in Sample 4-9, except that the addition amount of silicomolybdic acid was regulated to 0.50% by weight of the positive electrode active material.

<Sample 4-12>

A secondary battery was fabricated in the same manner as in Sample 4-9, except that the addition amount of silicomolybdic acid was regulated to 1.0% by weight of the positive electrode active material.

<Sample 4-13>

A secondary battery was fabricated in the same manner as in Sample 4-9, except that the addition of silicomolybdic acid was not performed.

[Evaluation of Test Battery]

Each of the test batteries was subjected to an evaluation test of blister amount of battery, a test of discharge capacity and an XPS analysis in the same manners as in Example 2.

The evaluation results are shown in the following Table 4.

TABLE 4

| | | | Addition | Presence of molybdenum ion | |
|---|---|---|---|---|---|
| | | | amount | Positive electrode surface | |
| | Positive electrode | | [% by | Valence of | Valence |
| | active material | Heteropolyacid | weight] | less than 6 | of 6 |
| Sample 4-1 | Li_{0.98}Co_{0.15}Ni_{0.80}Al_{0.05}O₂ | Silicomolybdic acid | 0.005 | No | Yes |
| Sample 4-2 | | Silicomolybdic acid | 0.20 | No | Yes |
| Sample 4-3 | | Silicomolybdic acid | 0.50 | No | Yes |
| Sample 4-4 | | Silicomolybdic acid | 1.0 | No | Yes |
| Sample 4-5 | | Silicomolybdic acid | 3.0 | No | Yes |
| Sample 4-6 | | Silicomolybdic acid | 5.0 | No | Yes |
| Sample 4-7 | | Silicomolybdic acid | 7.0 | No | Yes |
| Sample 4-8 | | — | — | No | No |
| Sample 4-9 | Li_{1.02}Co_{0.98}Mg_{0.01}Al_{0.01}O₂ | Silicomolybdic acid | 0.005 | No | Yes |
| Sample 4-10 | | Silicomolybdic acid | 0.20 | No | Yes |
| Sample 4-11 | | Silicomolybdic acid | 0.50 | No | Yes |
| Sample 4-12 | | Silicomolybdic acid | 1.0 | No | Yes |
| Sample 4-13 | | — | — | No | No |

| | Presence of molybdenum ion | | | |
|---|---|---|---|---|
| | Negative electrode surface | | Blister | Discharge |
| | Valence of | Valence | amount | capacity |
| | less than 6 | of 6 | [mm] | [mAh/g] |
| Sample 4-1 | Yes | No | 10.5 | 185.0 |
| Sample 4-2 | Yes | Yes | 4.00 | 183.8 |
| Sample 4-3 | Yes | Yes | 3.21 | 182.4 |
| Sample 4-4 | Yes | Yes | 2.73 | 181.7 |
| Sample 4-5 | Yes | Yes | 2.55 | 178.0 |
| Sample 4-6 | Yes | Yes | 2.29 | 170.1 |
| Sample 4-7 | Yes | Yes | 2.20 | 157.5 |
| Sample 4-8 | No | No | 16.2 | 185.3 |
| Sample 4-9 | Yes | No | 6.53 | — |
| Sample 4-10 | Yes | Yes | 3.45 | — |
| Sample 4-11 | Yes | Yes | 2.91 | — |
| Sample 4-12 | Yes | Yes | 2.53 | — |
| Sample 4-13 | No | No | 8.03 | — |

Samples 4-1 to 4-7 and Samples 4-9 to 4-12 are concerned with a secondary battery fabricated by adding silicomolybdic acid to the positive electrode. From the results of the XPS analysis shown in Table 4, in these secondary batteries, the molybdenum compound was confirmed to exist on the surface of each of the positive electrode and the negative electrode. Also, only a molybdenum ion with a valence of 6 was existent in the positive electrode, whereas a molybdenum ion with a valence of less than 6 was also contained in the negative electrode. In consequence, it was confirmed that in view of the fact that a part of silicomolybdic acid added to the positive electrode elutes, an averagely reduced molybdenum compound deposits and exists on the surface of the negative electrode as compared with the positive electrode.

As shown in Table 4, it was noted that in the secondary batteries constituted so as to add silicomolybdic acid to the positive electrode, thereby depositing the molybdenum compound on the negative electrode surface, the battery blister can be suppressed as compared with the secondary batteries of Samples 4-8 and 4-13 not containing silicomolybdic acid. In particular, it was noted that in the secondary batteries constituted in such a manner that the molybdenum compound having both a molybdenum ion with a valence of 6 and a molybdenum ion with a valence of less than 6 is deposited on the negative electrode surface, the battery blister can be remarkably suppressed as compared with the secondary batteries of Samples 4-1 and 4-9 in which only a molybdenum ion with a valence of less than 6 is existent.

Samples 4-1 to 4-8 are one using Li_{0.98}Co_{0.15}Ni_{0.80}Al_{0.05}O₂ as the positive electrode active material. As shown in Table 4, it was noted that by depositing the molybdenum compound so as to have both a molybdenum ion with a valence of 6 and a molybdenum ion with a valence of less than 6, the blister amount of the battery is small as compared with Sample 4-8 in which silicomolybdic acid is not added and Sample 4-1 in which a hexavalent molybdenum ion is not existent. Then, it was noted that the effect for suppressing the battery blister increases with an increase of the addition amount of silicomolybdic acid; and that when the addition amount of silicomolybdic acid is 1.0% by weight or more, the substantially equal effect is kept. Furthermore, the discharge capacity was lowered with an increase of the addition amount of silicomolybdic acid, and for example, when the addition amount of silicomolybdic acid was 7.0% by weight, the discharge capacity was abruptly lowered.

Samples 4-9 to 4-13 are one using Li_{1.02}Co_{0.98}Mg_{0.01}Al_{0.01}O₂ as the positive electrode active material. Similar to Samples 4-1 to 4-8, when the molybdenum compound was deposited so as to have both a molybdenum ion with a valence of 6 and a molybdenum ion with a valence of less than 6, the battery blister could be suppressed.

As noted from the comparison with Samples 4-8 and 4-13, when the positive electrode active material having a high content of nickel (Ni) is used, the gas generation amount is high, and the battery blister becomes large. However, in Samples 4-4 and 4-12 in which the same amount of silicomolybdic acid is added, the amount of the battery blister is substantially equal, and in particular, it was noted that the addition of silicomolybdic acid is remarkably effective for suppressing the battery blister against the secondary battery using a positive electrode active material having a high nickel (Ni) content.

### Example 5

### Case of Adding a Heteropolyacid to an Electrolytic Solution, Thereby Depositing at Least One of a Polyacid and a Polyacid Compound on a Negative Electrode Surface

<Sample 5-1>[Fabrication of Positive Electrode]

A positive electrode was fabricated in the same manner as in Sample 1-1, except that the addition of silicotungstic acid was not performed.

[Fabrication of Negative Electrode]

91% by weight of artificial graphite as a negative electrode active material and 9% by weight of powdery polyvinylidene fluoride as a binder were dispersed in N-methyl-2-pyrrolidone to prepare a negative electrode mixture slurry. Subsequently, this negative electrode mixture slurry was uniformly coated on the both surfaces of a copper foil serving as a negative electrode collector and dried under reduced pressure at 120° C. for 24 hours to form a negative electrode active material layer. Then, the resultant was subjected to pressure molding by a roll press to form a negative electrode sheet, and the negative electrode sheet was cut out into a strip form of 50 mm×310 mm, thereby fabricating a negative electrode. Finally, a negative electrode lead made of a nickel ribbon was welded to a negative electrode collector exposed portion in an end of the negative electrode.

[Preparation of Electrolytic Solution]

An electrolytic solution was prepared in the following manner. First of all, ethylene carbonate (EC) and diethyl carbonate (DEC) were mixed in a weight ratio of 4/6 to prepare a mixed solvent. Subsequently, lithium hexafluorophosphate (LiPF₆) was dissolved in a proportion of 1.0 mole/kg in the mixed solvent to prepare an electrolytic solution, in which was then further dissolved 0.005% by weight of silicotungstic acid (H₄(SiW₁₂O₄₀)).

[Preparation of Wound Electrode Body]

Subsequently, the above-fabricated strip-shaped positive electrode and strip-shaped negative electrode were laminated via a porous polyethylene separator having a thickness of 20 μm, and the laminate was wound in a longitudinal direction thereof, thereby obtaining a wound electrode body of a flat type. The positive electrode, the negative electrode and the separator have a structure in which an end of the negative electrode protrudes from an end of the positive electrode, and an end of the separator protrudes outside the end of the negative electrode. The wound electrode body was assembled in such a manner that a protruded width is equal on the both sides. This wound electrode body was interposed by a laminated film in which a resin layer was formed on the both surfaces of an aluminum foil, and the outer edges of the laminated film exclusive of one side were subjected to heat fusion.

Subsequently, the electrolytic solution was injected from the opening of the laminated film, and the remaining one side was sealed under a reduced pressure, thereby hermetically sealing the wound electrode body in the laminated film. A resin side was disposed in a part of each of the positive electrode lead and the negative electrode lead, and the laminated films were sealed in this portion while being opposed to each other.

Subsequently, the fabricated battery was preliminarily charged to 3.2 V at 100 mA, thereby achieving electrolytic reduction of silicotungstic acid. A change in the capacity of the positive electrode at this stage is extremely small such that it is negligible. According to this, a test secondary battery having a tungsten compound deposited on the negative electrode was fabricated.

<Sample 5-2>

A secondary battery was fabricated in the same manner as in Sample 5-1, except that the addition amount of silicotungstic acid was regulated to 0.20% by weight.

<Sample 5-3>

A secondary battery was fabricated in the same manner as in Sample 5-1, except that the addition amount of silicotungstic acid was regulated to 0.50% by weight.

<Sample 5-4>

A secondary battery was fabricated in the same manner as in Sample 5-1, except that the addition amount of silicotungstic acid was regulated to 1.0% by weight.

<Sample 5-5>

A secondary battery was fabricated in the same manner as in Sample 5-1, except that the addition amount of silicotungstic acid was regulated to 3.0% by weight.

<Sample 5-6>

A secondary battery was fabricated in the same manner as in Sample 5-1, except that the addition amount of silicotungstic acid was regulated to 5.0% by weight.

<Sample 5-7>

A secondary battery was fabricated in the same manner as in Sample 5-1, except that the addition of silicotungstic acid was not performed.

<Sample 5-8>

A secondary battery was fabricated in the same manner as in Sample 5-1, except that 0.005% by weight of phosphomolybdic acid was added as the heteropolyacid.

<Sample 5-9>

A secondary battery was fabricated in the same manner as in Sample 5-8, except that the addition amount of phosphomolybdic acid was regulated to 0.20% by weight.

<Sample 5-10>

A secondary battery was fabricated in the same manner as in Sample 5-8, except that the addition amount of phosphomolybdic acid was regulated to 0.50% by weight.

<Sample 5-11>

A secondary battery was fabricated in the same manner as in Sample 5-8, except that the addition amount of phosphomolybdic acid was regulated to 1.0% by weight.

<Sample 5-12>

A secondary battery was fabricated in the same manner as in Sample 5-8, except that the addition amount of phosphomolybdic acid was regulated to 3.0% by weight.

<Sample 5-13>

A secondary battery was fabricated in the same manner as in Sample 5-8, except that the addition amount of phosphomolybdic acid was regulated to 5.0% by weight.

<Sample 5-14>

A secondary battery was fabricated in the same manner as in Sample 5-1, except that 0.005% by weight of phosphotungstic acid was added as the heteropolyacid.

<Sample 5-15>

A secondary battery was fabricated in the same manner as in Sample 5-14, except that the addition amount of phosphotungstic acid was regulated to 0.20% by weight.

<Sample 5-16>

A secondary battery was fabricated in the same manner as in Sample 5-14, except that the addition amount of phosphotungstic acid was regulated to 0.50% by weight.

<Sample 5-17>

A secondary battery was fabricated in the same manner as in Sample 5-14, except that the addition amount of phosphotungstic acid was regulated to 1.0% by weight.

<Sample 5-18>

A secondary battery was fabricated in the same manner as in Sample 5-14, except that the addition amount of phosphotungstic acid was regulated to 3.0% by weight.

<Sample 5-19>

A secondary battery was fabricated in the same manner as in Sample 5-14, except that the addition amount of phosphotungstic acid was regulated to 5.0% by weight.

<Sample 5-20>

A secondary battery was fabricated in the same manner as in Sample 5-1, except that 0.005% by weight of silicomolybdic acid was added as the heteropolyacid.

<Sample 5-21>

A secondary battery was fabricated in the same manner as in Sample 5-20, except that the addition amount of silicomolybdic acid was regulated to 0.20% by weight.

<Sample 5-22>

A secondary battery was fabricated in the same manner as in Sample 5-20, except that the addition amount of silicomolybdic acid was regulated to 0.50% by weight.

<Sample 5-23>

A secondary battery was fabricated in the same manner as in Sample 5-20, except that the addition amount of silicomolybdic acid was regulated to 1.0% by weight.

<Sample 5-24>

A secondary battery was fabricated in the same manner as in Sample 5-20, except that the addition amount of silicomolybdic acid was regulated to 3.0% by weight.

<Sample 5-25>

A secondary battery was fabricated in the same manner as in Sample 5-20, except that the addition amount of silicomolybdic acid was regulated to 5.0% by weight.

[Evaluation of Test Battery]

Each of the test batteries was subjected to an evaluation test of blister amount of battery in the same manner as in Example 1. Also, the same XPS analysis as in Examples 1 and 2 was applied to the negative electrode. Also, a safety evaluation test was performed in the following manner.

(a) Heating Test

The test battery was disposed in an environment at room temperature and subjected to constant-current charge with 1 C. Thereafter, at a point of time when a battery voltage reached 4.5 V, the charge manner was switched to constant-voltage charge, and the test battery was charged in an overcharged state. Thereafter, the test battery was placed in a thermostat at room temperature, and the temperature was elevated at a rate of 5° C./min. At a point of time when the temperature reached 150° C., the constant temperature was kept, and the test battery was kept from that point of time for one hour.

(b) Nail Penetration Test

The test battery was disposed in an environment at 60° C. and subjected to constant-current charge with 1 C. Thereafter, at a point of time when a battery voltage reached 4.5 V, the charge manner was switched to constant-voltage charge, and the test battery was charged in an overcharged state. Thereafter, a nail having a diameter of 2.5 mm was penetrated into the test battery in an environment at 60° C.

(c) Overcharge Test

The test battery in a discharged state was disposed in an environment at room temperature, and the test battery was overcharged from the discharged state to an upper limit of 24 V with a large current of 5 C.

The results of each of the foregoing tests are shown in Table 5. In the heating test, the nail penetration test and the overcharge test, the case where any change was not observed is designated as “0”. On the other hand, the case where the laminated film expanded due to the heat generation is designated as “1”; the case where gentle smoking occurred is designated as “2”; and the case where gas spouting occurred is designated as “3”.

TABLE 5

| | | | Presence of W or Mo ion on | | | | | |
|---|---|---|---|---|---|---|---|---|
| | | Addition | negative electrode surface | | Blister | | Nail | |
| | | amount | Valence of | Valence | amount | Heat | penetration | Overcharge |
| | Heteropolyacid | [% by weight] | less than 6 | of 6 | [mm] | test | test | test |
| Sample 5-1 | Silicotungstic acid | 0.005 | Yes | No | 9.10 | 2 | 3 | 2 |
| Sample 5-2 | Silicotungstic acid | 0.20 | Yes | Yes | 3.16 | 1 | 1 | 1 |
| Sample 5-3 | Silicotungstic acid | 0.50 | Yes | Yes | 2.57 | 1 | 0 | 1 |
| Sample 5-4 | Silicotungstic acid | 1.0 | Yes | Yes | 2.54 | 1 | 0 | 0 |
| Sample 5-5 | Silicotungstic acid | 3.0 | Yes | Yes | 2.10 | 0 | 1 | 0 |
| Sample 5-6 | Silicotungstic acid | 5.0 | Yes | Yes | 1.95 | 0 | 1 | 0 |
| Sample 5-7 | — | — | No | No | 17.3 | 2 | 3 | 3 |
| Sample 5-8 | Phosphomolybdic acid | 0.005 | Yes | No | 9.32 | 2 | 3 | 2 |
| Sample 5-9 | Phosphomolybdic acid | 0.20 | Yes | Yes | 3.22 | 1 | 0 | 1 |
| Sample 5-10 | Phosphomolybdic acid | 0.50 | Yes | Yes | 2.75 | 0 | 0 | 1 |
| Sample 5-11 | Phosphomolybdic acid | 1.0 | Yes | Yes | 2.60 | 0 | 0 | 1 |
| Sample 5-12 | Phosphomolybdic acid | 3.0 | Yes | Yes | 2.45 | 0 | 1 | 0 |
| Sample 5-13 | Phosphomolybdic acid | 5.0 | Yes | Yes | 2.29 | 0 | 1 | 0 |
| Sample 5-14 | Phosphotungstic acid | 0.005 | Yes | No | 9.24 | 2 | 3 | 2 |
| Sample 5-15 | Phosphotungstic acid | 0.20 | Yes | Yes | 3.20 | 1 | 1 | 0 |
| Sample 5-16 | Phosphotungstic acid | 0.50 | Yes | Yes | 2.68 | 1 | 0 | 1 |
| Sample 5-17 | Phosphotungstic acid | 1.0 | Yes | Yes | 2.55 | 0 | 1 | 0 |
| Sample 5-18 | Phosphotungstic acid | 3.0 | Yes | Yes | 2.38 | 0 | 0 | 0 |
| Sample 5-19 | Phosphotungstic acid | 5.0 | Yes | Yes | 2.10 | 0 | 1 | 0 |
| Sample 5-20 | Silicomolybdic acid | 0.005 | Yes | No | 9.12 | 2 | 3 | 2 |
| Sample 5-21 | Silicomolybdic acid | 0.20 | Yes | Yes | 3.10 | 1 | 1 | 1 |
| Sample 5-22 | Silicomolybdic acid | 0.50 | Yes | Yes | 2.67 | 0 | 0 | 1 |
| Sample 5-23 | Silicomolybdic acid | 1.0 | Yes | Yes | 2.48 | 0 | 0 | 1 |
| Sample 5-24 | Silicomolybdic acid | 3.0 | Yes | Yes | 2.30 | 0 | 1 | 0 |
| Sample 5-25 | Silicomolybdic acid | 5.0 | Yes | Yes | 1.99 | 0 | 1 | 0 |

As shown in Table 5, it was noted that in the secondary batteries constituted so as to deposit the polyacid compound on the negative electrode surface, the battery blister can be suppressed as compared with the secondary battery of Sample 5-7 not containing silicotungstic acid. In particular, it was noted that in the secondary batteries constituted so as to deposit the molybdenum compound having both a molybdenum ion with a valence of 6 and a molybdenum ion with a valence of less than 6, or the tungsten compound having both a tungsten ion with a valence of 6 and a tungsten ion with a valence of less than 6, on the negative electrode surface, the battery blister can be remarkably suppressed as compared with the secondary batteries of Samples 5-1, 5-8, 5-14 and 5-20 in which only a tungsten ion with a valence of less than 6 or a molybdenum ion with a valence of less than 6 is existent.

Also, in Samples 5-2 to 5-6, 5-9 to 5-13, 5-15 to 5-19 and 5-21 to 5-25, in which the heteropolyacid is added to the electrolytic solution, and the polyacid compound is deposited on the negative electrode so as to have a polyatom ion with a valence of 6 and a polyatom ion with a valence of less than 6, any problem was not caused in the respective tests, or the laminated film was merely expanded. On the other hand, in Samples 5-1, 5-7, 5-8, 5-14 and 5-20 in which the polyacid is not added to the electrolytic solution, or the valences of ions of the polyacid compounds deposited on the negative electrode are all less than 6, gentle smoking or gas spouting of the test battery occurred.

In consequence, in the secondary batteries having a configuration in which the polyacid compound is deposited on the negative electrode so as to have both a polyatom ion with a valence of 6 and a polyatom ion with a valence of less than 6, suppression of the battery blister and enhancement of the safety were confirmed.

### Example 6

### Case of Adding a Heteropolyacid to a Negative Electrode Active Material Layer, Thereby Depositing at Least One of a Polyacid and a Polyacid Compound on a Negative Electrode Surface

<Sample 6-1>

[Fabrication of Positive Electrode]

A positive electrode was fabricated in the same manner as in Example 1-1.

[Fabrication of Negative Electrode]

91% by weight of artificial graphite as a negative electrode active material and 9% by weight of powdered polyvinylidene fluoride as a binder were dry mixed. Subsequently, N-methyl-2-pyrrolidone was added to this mixture to prepare a negative electrode mixture slurry. Meanwhile, silicotungstic acid (H₄(SiW₁₂O₄₀)) was dissolved in N-methyl-2-pyrrolidone, thereby preparing a silicotungstic acid solution having a concentration of 5.0% by mass. Then, the silicotungstic acid solution in which the addition amount of silicotungstic acid was corresponding to 0.005% by mass relative to the negative electrode active material was added to the negative electrode mixture slurry. A negative electrode was fabricated in the same manner as in Example 2-1, except for the foregoing.

[Preparation of Electrolytic Solution]

An electrolytic solution was prepared in the same manner as in Example 5-1, except that silicotungstic acid was not added.

[Fabrication of Wound Electrode Body]

A test battery was fabricated in the same manner as in Example 5-1 by using the foregoing positive electrode, negative electrode and electrolytic solution. The fabricated battery was preliminarily charged to 3.2 V at 100 mA, thereby achieving electrolytic reduction of silicotungstic acid. A change in the capacity of the positive electrode at this stage is extremely small such that it is negligible. According to this, a test secondary battery in which the tungsten compound in which at least a part of tungsten ions was reduced was deposited on the negative electrode was fabricated.

<Sample 6-2>

A secondary battery was fabricated in the same manner as in Sample 6-1, except that the addition amount of silicotungstic acid was regulated to 0.20% by weight of the negative electrode active material.

<Sample 6-3>

A secondary battery was fabricated in the same manner as in Sample 6-1, except that the addition amount of silicotungstic acid was regulated to 0.50% by weight of the negative electrode active material.

<Sample 6-4>

A secondary battery was fabricated in the same manner as in Sample 6-1, except that the addition amount of silicotungstic acid was regulated to 1.0% by weight of the negative electrode active material.

<Sample 6-5>

A secondary battery was fabricated in the same manner as in Sample 6-1, except that the addition amount of silicotungstic acid was regulated to 3.0% by weight of the negative electrode active material.

<Sample 6-6>

A secondary battery was fabricated in the same manner as in Sample 6-1, except that the addition amount of silicotungstic acid was regulated to 5.0% by weight of the negative electrode active material.

<Sample 6-7>

A secondary battery was fabricated in the same manner as in Sample 6-1, except that the addition of silicotungstic acid was not performed.

<Sample 6-8>

A secondary battery was fabricated in the same manner as in Sample 6-1, except that 0.005% by weight of phosphomolybdic acid relative to the negative electrode active material was added as the heteropolyacid.

<Sample 6-9>

A secondary battery was fabricated in the same manner as in Sample 6-8, except that the addition amount of phosphomolybdic acid was regulated to 0.20% by weight of the negative electrode active material.

<Sample 6-10>

A secondary battery was fabricated in the same manner as in Sample 6-8, except that the addition amount of phosphomolybdic acid was regulated to 0.50% by weight of the negative electrode active material.

<Sample 6-11>

A secondary battery was fabricated in the same manner as in Sample 6-8, except that the addition amount of phosphomolybdic acid was regulated to 1.0% by weight of the negative electrode active material.

<Sample 6-12>

A secondary battery was fabricated in the same manner as in Sample 6-8, except that the addition amount of phosphomolybdic acid was regulated to 3.0% by weight of the negative electrode active material.

<Sample 6-13>

A secondary battery was fabricated in the same manner as in Sample 6-8, except that the addition amount of phosphomolybdic acid was regulated to 5.0% by weight of the negative electrode active material.

<Sample 6-14>

A secondary battery was fabricated in the same manner as in Sample 6-1, except that 0.005% by weight of phosphotungstic acid relative to the negative electrode active material was added as the heteropolyacid.

<Sample 6-15>

A secondary battery was fabricated in the same manner as in Sample 6-14, except that the addition amount of phosphotungstic acid was regulated to 0.20% by weight of the negative electrode active material.

<Sample 6-16>

A secondary battery was fabricated in the same manner as in Sample 6-14, except that the addition amount of phosphotungstic acid was regulated to 0.50% by weight of the negative electrode active material.

<Sample 6-17>

A secondary battery was fabricated in the same manner as in Sample 6-14, except that the addition amount of phosphotungstic acid was regulated to 1.0% by weight of the negative electrode active material.

<Sample 6-18>

A secondary battery was fabricated in the same manner as in Sample 6-14, except that the addition amount of phosphotungstic acid was regulated to 3.0% by weight of the negative electrode active material.

<Sample 6-19>

A secondary battery was fabricated in the same manner as in Sample 6-14, except that the addition amount of phosphotungstic acid was regulated to 5.0% by weight of the negative electrode active material.

<Sample 6-20>

A secondary battery was fabricated in the same manner as in Sample 6-1, except that 0.005% by weight of silicomolybdic acid relative to the negative electrode active material was added as the heteropolyacid.

<Sample 6-21>

A secondary battery was fabricated in the same manner as in Sample 6-20, except that the addition amount of silicomolybdic acid was regulated to 0.20% by weight of the negative electrode active material.

<Sample 6-22>

A secondary battery was fabricated in the same manner as in Sample 6-20, except that the addition amount of silicomolybdic acid was regulated to 0.50% by weight of the negative electrode active material.

<Sample 6-23>

A secondary battery was fabricated in the same manner as in Sample 6-20, except that the addition amount of silicomolybdic acid was regulated to 1.0% by weight of the negative electrode active material.

<Sample 6-24>

A secondary battery was fabricated in the same manner as in Sample 6-20, except that the addition amount of silicomolybdic acid was regulated to 3.0% by weight of the negative electrode active material.

<Sample 6-25>

A secondary battery was fabricated in the same manner as in Sample 6-20, except that the addition amount of silicomolybdic acid was regulated to 5.0% by weight of the negative electrode active material.

[Evaluation of Test Battery]

Each of the test batteries was subjected to an evaluation test of blister amount of battery, an XPS analysis of the negative electrode surface and an evaluation test of safety in the same manners as in Example 5.

The results of each of the foregoing tests are shown in Table 6.

TABLE 6

| | | | Presence of W or Mo ion on | | | | | |
|---|---|---|---|---|---|---|---|---|
| | | Addition | negative electrode surface | | Blister | | Nail | |
| | | amount | Valence of | Valence | amount | Heat | penetration | Overcharge |
| | Heteropolyacid | [% by weight] | less than 6 | of 6 | [mm] | test | test | test |
| Sample 6-1 | Silicotungstic acid | 0.005 | Yes | No | 9.10 | 2 | 3 | 2 |
| Sample 6-2 | Silicotungstic acid | 0.20 | Yes | Yes | 3.09 | 1 | 1 | 1 |
| Sample 6-3 | Silicotungstic acid | 0.50 | Yes | Yes | 2.44 | 1 | 0 | 1 |
| Sample 6-4 | Silicotungstic acid | 1.0 | Yes | Yes | 2.37 | 1 | 0 | 0 |
| Sample 6-5 | Silicotungstic acid | 3.0 | Yes | Yes | 1.89 | 0 | 1 | 0 |
| Sample 6-6 | Silicotungstic acid | 5.0 | Yes | Yes | 1.88 | 0 | 1 | 0 |
| Sample 6-7 | — | — | No | No | 17.9 | 2 | 3 | 3 |
| Sample 6-8 | Phosphomolybdic acid | 0.005 | Yes | No | 9.27 | 2 | 3 | 3 |
| Sample 6-9 | Phosphomolybdic acid | 0.20 | Yes | Yes | 3.59 | 1 | 0 | 1 |
| Sample 6-10 | Phosphomolybdic acid | 0.50 | Yes | Yes | 2.60 | 0 | 0 | 1 |
| Sample 6-11 | Phosphomolybdic acid | 1.0 | Yes | Yes | 2.49 | 0 | 0 | 1 |
| Sample 6-12 | Phosphomolybdic acid | 3.0 | Yes | Yes | 2.32 | 0 | 0 | 0 |
| Sample 6-13 | Phosphomolybdic acid | 5.0 | Yes | Yes | 2.17 | 0 | 1 | 0 |
| Sample 6-14 | Phosphotungstic acid | 0.005 | Yes | No | 9.13 | 2 | 3 | 2 |
| Sample 6-15 | Phosphotungstic acid | 0.20 | Yes | Yes | 3.50 | 1 | 1 | 1 |
| Sample 6-16 | Phosphotungstic acid | 0.50 | Yes | Yes | 2.43 | 0 | 0 | 1 |
| Sample 6-17 | Phosphotungstic acid | 1.0 | Yes | Yes | 2.23 | 0 | 1 | 0 |
| Sample 6-18 | Phosphotungstic acid | 3.0 | Yes | Yes | 2.09 | 1 | 0 | 1 |
| Sample 6-19 | Phosphotungstic acid | 5.0 | Yes | Yes | 2.01 | 0 | 1 | 0 |
| Sample 6-20 | Silicomolybdic acid | 0.005 | Yes | No | 9.04 | 2 | 3 | 2 |
| Sample 6-21 | Silicomolybdic acid | 0.20 | Yes | Yes | 3.38 | 1 | 1 | 0 |
| Sample 6-22 | Silicomolybdic acid | 0.50 | Yes | Yes | 2.53 | 0 | 1 | 1 |
| Sample 6-23 | Silicomolybdic acid | 1.0 | Yes | Yes | 2.41 | 0 | 1 | 0 |
| Sample 6-24 | Silicomolybdic acid | 3.0 | Yes | Yes | 2.07 | 0 | 1 | 0 |
| Sample 6-25 | Silicomolybdic acid | 5.0 | Yes | Yes | 2.05 | 0 | 1 | 0 |

As shown in Table 6, it was noted that in the secondary batteries constituted so as to deposit the polyacid compound on the negative electrode surface, the battery blister can be suppressed as compared with the secondary battery of Sample 6-7 not containing silicotungstic acid. In particular, it was noted that in the secondary batteries constituted so as to deposit the molybdenum compound having both a molybdenum ion with a valence of 6 and a molybdenum ion with a valence of less than 6, or the tungsten compound having both a tungsten ion with a valence of 6 and a tungsten ion with a valence of less than 6, on the negative electrode surface, the battery blister can be remarkably suppressed as compared with the secondary batteries of Samples 6-1, 6-8, 6-14 and 6-20 in which only a tungsten ion with a valence of less than 6 or a molybdenum ion with a valence of less than 6 is existent.

Also, in Samples 6-2 to 6-6, 6-9 to 6-13, 6-15 to 6-19 and 6-21 to 6-25, in which the heteropolyacid is added to the electrolytic solution, and the polyacid compound is deposited on the negative electrode so as to have both a polyatom ion with a valence of 6 and a polyatom ion with a valence of less than 6, any problem was not caused in the respective tests, or the laminated film was merely expanded. On the other hand, in Samples 6-1, 6-7, 6-8, 6-14 and 6-20 in which the polyacid is not added to the electrolytic solution, or the valences of tungsten or molybdenum ions deposited on the negative electrode are all less than 6, gentle smoking or gas spouting of the test battery occurred.

In consequence, in the secondary batteries having a constitution in which the polyacid compound is deposited on the negative electrode so as to have both a polyatom ion with a valence of 6 and a polyatom ion with a valence of less than 6, suppression of the battery blister and enhancement of the safety were confirmed.

As described above, in the nonaqueous electrolyte battery having a constitution in which a tungsten or molybdenum compound is deposited on the negative electrode by the addition of a heteropolyacid so as to have both a polyatom ion with a valence of 6 and a polyatom ion with a valence of less than 6, a nonaqueous electrolyte battery in which the gas generation and the generation of a short circuit between a positive electrode and a negative electrode can be suppressed, the battery blister is small, and the safety is high can be obtained. Such effects can be obtained in any battery configuration.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte battery comprising:
a positive electrode having a positive electrode active material layer containing a positive electrode active material formed on at least one surface of a positive electrode collector;
a negative electrode having a negative electrode active material layer containing a negative electrode active material formed on at least one surface of a negative electrode collector;
a separator provided between the positive electrode and the negative electrode; and
an electrolyte, wherein
a coating film in a gel form containing an amorphous polyacid and/or polyacid compound containing one or more kinds of a polyelement is formed on the surface of at least a part of the negative electrode, and
at least one of the polyacid and the polyacid compound contains a polyatom ion with a valence of 6 and a polyatom ion with a valence of less than 6.

2. The nonaqueous electrolyte battery according to claim 1, wherein said amorphous polyacid and/or polyacid compound is deposited by electrolysis of at least one of a polyacid and a polyacid compound.

3. The nonaqueous electrolyte battery according to claim 1, wherein
the coating film in a gel form has a three-dimensional network structure with the electrolyte absorbed therein.

4. The nonaqueous electrolyte battery according to claim 2, wherein
the polyacid and the polyacid compound are a heteropolyacid and a heteropolyacid compound, respectively and wherein
said amorphous polyacid and/or polyacid compound is deposited by electrolysis of at least one of said heteropolyacid and said heteropolyacid compound.

5. The nonaqueous electrolyte battery according to claim 1, wherein
when the surface of the polyacid or polyacid compound existent on the negative electrode is measured by the X-ray photoelectron spectroscopy (XPS), a spectrum assigned to an inner shell electron of 4f7/2 of tungsten has a peak in each of a region of 32.0 eV or more and not more than 35.4 eV and a region of 35.4 eV or more and not more than 36.9 eV.

6. The nonaqueous electrolyte battery according to claim 1, wherein
when the surface of the polyacid or polyacid compound existent on the negative electrode is measured by the X-ray photoelectron spectroscopy (XPS), a spectrum assigned to an inner shell electron of 3d5/2 of molybdenum has a peak in each of a region of 227.0 eV or more and not more than 231.5 eV and 231.5 eV or more and not more than 233.0 eV.

7. The nonaqueous electrolyte battery according to claim 4, wherein
each of the polyacid and the polyacid compound is
one having a polyatom selected from the following element group (a); or
one having a polyatom selected from the following element group (a), in which a part of the polyatoms is substituted with at least any one element selected from the following element group (b):
Element group (a): Mo, W, Nb, V
Element group (b): Ti, Cr, Mn, Fe, Co, Ni, Cu, Zn, Ga, Zr, Tc, Rh, Cd, In, Sn, Ta, Re, Tl, Pb

8. The nonaqueous electrolyte battery according to claim 4, wherein
each of the heteropolyacid and the heteropolyacid compound is
one having a polyatom selected from the following element group (a); or
one having a polyatom selected from the following element group (a), in which a part of the polyatoms is substituted with at least any one element selected from the following element group (b):
Element group (a): Mo, W, Nb, V
Element group (b): Ti, Cr, Mn, Fe, Co, Ni, Cu, Zn, Ga, Zr, Tc, Rh, Cd, In, Sn, Ta, Re, Tl, Pb

9. The nonaqueous electrolyte battery according to claim 1, wherein
each of the heteropolyacid and the heteropolyacid compound is
one having a hetero atom selected from the following element group (c); or
one having a hetero atom selected from the following element group (c), in which a part of the hetero atoms is substituted with at least any one element selected from the following element group (d):
Element group (c): B, Al, Si, P, Cr, Mn, Fe, Co, Ni, Cu, Zn, Ge, As
Element group (d): H, Be, B, C, Na, Al, Si, P, S, Ti, V, Cr, Mn, Fe, Co, Ni, Cu, Zn, Ga, Ge, As, Se, Zr, Rh, Sn, Sb, Te, I, Re, Pt, Bi, Ce, Th, U, Np

10. The nonaqueous electrolyte battery according to claim 1, wherein
at least one of the polyacid and the polyacid compound exists on the surface of at least a part of each of the positive electrode and the negative electrode; and
an average valence of the polyatom ion contained in at least one of the polyacid and the polyacid compound deposited on the positive electrode is in an oxidized state as compared with an average valence of the polyatom ion contained in at least one of the polyacid and the polyacid compound deposited on the negative electrode.

11. The nonaqueous electrolyte battery according to claim 1, wherein
at least one of the amorphous polyacid and the polyacid compound exists on the surface of at least a part of the negative electrode,
intervenes between the negative electrode and the separator opposing to the negative electrode, and thereby mutually immobilizes the negative electrode and the separator.

12. The nonaqueous electrolyte battery according to claim 1, wherein
an average composition of the positive electrode active material is represented by the following formula (1) or (2):
LiₐCo_{b}Ni_{c}M1_{1-b-c}O_{d} (1)
wherein
M1 is at least one element selected from the group consisting of boron (B), magnesium (Mg), aluminum (Al), silicon (Si), phosphorus (P), sulfur (S), titanium (Ti), chromium (Cr), manganese (Mn), iron (Fe), copper (Cu), zinc (Zn), gallium (Ga), germanium (Ge), yttrium (Y), zirconium (Zr), molybdenum (Mo), silver (Ag), barium (Ba), tungsten (W), indium (In), tin (Sn), lead (Pb) and antimony (Sb); a, b, c and d are values falling within the ranges of (0.2≦a≦1.4), (0≦b≦1.0), (0≦c≦1.0) and (1.8≦d≦2.2), respectively; the composition of lithium varies depending upon the charge/discharge state; and the value of a represents a value in a completely discharged state, and
LiₕMn₂₋ᵢM2ᵢOⱼ (2)
wherein
M2 is at least one member selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W); h, i and j are values falling within the ranges of (0.9≦h≦1.1), (0≦i≦0.6) and (3.7≦j≦4.1), respectively; the composition of lithium varies depending upon the charge/discharge state; and the value of h represents a value in a completely discharged state.
